(19) United States
(12) Patent Application Publication
(10) Pub. No.: US 2026/0175225 A1
(43) Pub. Date: Jun. 25, 2026

(54) ANALYSIS APPARATUS AND ANALYSIS METHOD

(71) Applicant: CANON MEDICAL SYSTEMS CORPORATION, Otawara-shi (JP)

(72) Inventors: Kenta KAMINO, Mibu-machi (JP); Hirotoshi TAHARA, Ota (JP); Takanori HIRANO, Nasushiobara (JP); Hiroto SATAKE, Brighton, MA (US); Shunsuke FUJIWARA, Utsunomiya (JP); Keisuke SUGAHARA, Nasushiobara (JP)

(73) Assignee: CANON MEDICAL SYSTEMS CORPORATION, Otawara-shi (JP)

(21) Appl. No.: 19/425,003

(22) Filed: Dec. 18, 2025

(30) Foreign Application Priority Data
Dec. 25, 2024 (JP) 2024-229497

(51) Int. Cl. B01L 3/00

(52) U.S. Cl. CPC B01L 3/502792; B01L 3/502715; B01L 2200/0605; B01L 2300/0645; B01L 2300/0867; B01L 2300/1811

(57) ABSTRACT

An analysis apparatus according to embodiments is an apparatus that performs analysis related to a target substance included in a sample by moving a liquid droplet through application of an electric field includes a liquid droplet generation unit, a first measurement unit, a second measurement unit, and processing circuitry. The liquid droplet generation unit generates a liquid droplet to be used for the analysis. The first measurement unit measures a size of the liquid droplet. The second measurement unit performs measurement related to the target substance using the liquid droplet. The processing circuitry analyzes an amount of the target substance in the sample based on a measured size of the liquid droplet and a result of the measurement related to the target substance.

### CROSS-REFERENCE TO RELATED APPLICATIONS

This application is based upon and claims the benefit of priority from Japanese Patent Application No. 2024-229497, filed Dec. 25, 2024, the entire contents of which are incorporated herein by reference.

### FIELD

Embodiments described herein relate generally to an analysis apparatus and an analysis method.

### BACKGROUND

Conventionally, there has been a technology known as digital microfluidics (DMF) that enables manipulation of liquid droplets on substrates using electric signals. According to the DMF technology, for example, it is possible to manipulate a liquid droplet on a conductive substrate by applying an electric field in accordance with an electric signal, based on a principle called electrowetting on a dielectric material. Due to its high degree of freedom in liquid droplet manipulation and small reaction volume, the DMF technology has been applied to point-of-care testing (POCT) and improvement in efficiency of bioanalytical reactions.

When applying the DMF technology to quantitative analysis, such as biochemical testing and bio-sample analysis, the accuracy of dispensing samples and reagents becomes an issue. However, because a patient specimen that is used as a sample varies in composition and physical properties depending on the individual, it is difficult to reproducibly dispense liquid droplets using the DMF technology. If dispensing of a liquid droplet containing a sample or a reagent fails for any reason, using such a liquid droplet for measurement may reduce accuracy of test results. For example, if an amount of the sample relative to an amount of reagent is too large or too small, it may not be possible to accurately analyze an amount of a target substance in the sample.

### BRIEF DESCRIPTION OF THE DRAWINGS

FIG. 1 is a block diagram illustrating a configuration example of an analysis apparatus according to a first embodiment;

FIG. 2 is a schematic plan view illustrating a configuration example of a fluidic device of an analysis apparatus according to the first embodiment;

FIG. 3 is a cross-sectional view illustrating a configuration example of the fluidic device of the analysis apparatus according to the first embodiment;

FIG. 4 is a cross-sectional view illustrating a configuration example of a sample liquid droplet generation unit in the analysis apparatus according to the first embodiment;

FIG. 5 is a cross-sectional view illustrating another configuration example of the sample liquid droplet generation unit in the analysis apparatus according to the first embodiment;

FIG. 6 is a cross-sectional view illustrating a configuration example of a first reagent liquid droplet generation unit in the analysis apparatus according to the first embodiment;

FIG. 7 is a cross-sectional view illustrating a configuration example of a second reagent liquid droplet generation unit in the analysis apparatus according to the first embodiment;

FIG. 8 is a cross-sectional view illustrating a configuration example of a second measurement unit in the analysis apparatus according to the first embodiment;

FIG. 9 is a cross-sectional view illustrating another configuration example of a second measurement unit in the analysis apparatus according to the first embodiment;

FIG. 10 is a flowchart illustrating an operation example of the analysis apparatus according to the first embodiment;

FIG. 11 is a schematic plan view illustrating an operation example of the analysis apparatus according to the first embodiment;

FIG. 12 is a schematic plan view illustrating an operation example of the analysis apparatus according to the first embodiment;

FIG. 13 is a schematic plan view illustrating a configuration example of a fluidic device in an analysis apparatus according to Modified Example 1 of the first embodiment;

FIG. 14 is a schematic plan view illustrating a configuration example of a fluidic device in an analysis apparatus according to Modified Example 2 of the first embodiment;

FIG. 15 is a schematic plan view illustrating a configuration example of a fluidic device in an analysis apparatus according to Modified Example 3 of the first embodiment;

FIG. 16 is a schematic plan view illustrating a configuration example of a fluidic device in an analysis apparatus according to Modified Example 4 of the first embodiment;

FIG. 17 is a flowchart illustrating an operation example of an analysis apparatus according to Modified Example 5 of the first embodiment;

FIG. 18 is a schematic plan view illustrating an operation example of the analysis apparatus according to the Modified Example 5 of the first embodiment;

FIG. 19 is a schematic plan view illustrating an operation example of the analysis apparatus according to the Modified Example 5 of the first embodiment, following the operation illustrated in FIG. 18;

FIG. 20 is a schematic plan view illustrating an operation example of the analysis apparatus according to the Modified Example 5 of the first embodiment, following the operation illustrated in FIG. 18;

FIG. 21 is a schematic plan view illustrating an operation example of the analysis apparatus according to the Modified Example 5 of the first embodiment, following the operation illustrated in FIG. 20;

FIG. 22 is a block diagram illustrating a configuration example of an analysis apparatus according to a second embodiment;

FIG. 23 is a schematic plan view illustrating a configuration example of a fluidic device in the analysis apparatus according to the second embodiment;

FIG. 24 is a flowchart illustrating an operation example of the analysis apparatus according to the second embodiment;

FIG. 25 is a schematic diagram illustrating contamination in the analysis apparatus according to the second embodiment;

FIG. 26 is a block diagram illustrating a configuration example of an analysis apparatus according to a third embodiment;

FIG. 27 is a schematic plan view illustrating a configuration example of a fluidic device in the analysis apparatus according to the third embodiment;

FIG. 28 is a block diagram illustrating a configuration example of an analysis apparatus according to a fourth embodiment;

FIG. 29 is a schematic plan view illustrating a configuration example of a fluidic device in the analysis apparatus according to the fourth embodiment;

FIG. 30 is a block diagram illustrating a configuration example of an analysis apparatus according to a fifth embodiment;

FIG. 31 is a schematic plan view illustrating a configuration example of a fluidic device in the analysis apparatus according to the fifth embodiment;

FIG. 32 is a block diagram illustrating a configuration example of an analysis apparatus according to a sixth embodiment; and

FIG. 33 is a flowchart illustrating an operation example of the analysis apparatus according to the sixth embodiment.

### DETAILED DESCRIPTION

An analysis apparatus according to embodiments is an apparatus that performs analysis related to a target substance included in a sample by moving a liquid droplet through application of an electric field includes a liquid droplet generation unit, a first measurement unit, a second measurement unit, and processing circuitry. The liquid droplet generation unit generates a liquid droplet to be used for the analysis. The first measurement unit measures a size of the liquid droplet. The second measurement unit performs measurement related to the target substance using the liquid droplet. The processing circuitry analyzes an amount of the target substance in the sample based on a measured size of the liquid droplet and a result of the measurement related to the target substance.

Various embodiments will be described hereinafter with reference to the accompanying drawings.

In the following description, components having substantially the same function and configuration are assigned the same reference numeral, and the redundant description will be given only if it is necessary.

### First Embodiment

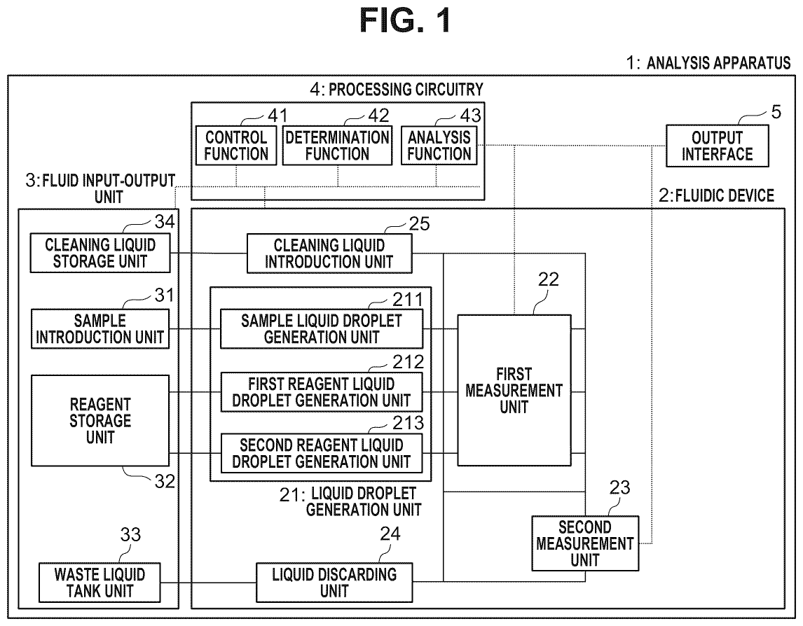

FIG. 1 is a block diagram illustrating a configuration example of an analysis apparatus 1 according to the first embodiment. The analysis apparatus 1 is an apparatus that performs analysis on a target substance contained in a sample by moving a liquid droplet through application of an electric field. For example, electrowetting on a dielectric material is used for the movement of the liquid droplet. The electrowetting on a dielectric material is a method of moving a liquid droplet on the dielectric material by changing wettability of the liquid droplet by applying an electric field. In the following description, “electrowetting on a dielectric material” will be simply referred to as “electrowetting”.

As illustrated in FIG. 1, the analysis apparatus 1 according to the present embodiment includes, for example, a fluidic device 2, a fluid input-output unit 3, processing circuitry 4, and an output interface 5.

The fluidic device 2 is a digital microfluidics (DMF) device based on DMF technology. More specifically, the fluidic device 2 includes a plurality of electrodes, and performs operations, such as dispensing, moving, mixing, agitating, and still standing, of a liquid droplet using the electrowetting. In the following description, the dispensing of a liquid droplet will be sometimes referred to as the “generation” of the liquid droplet.

The fluidic device 2 includes, for example, a liquid droplet generation unit 21, a first measurement unit 22, a second measurement unit 23, a liquid discarding unit 24, and a cleaning liquid introduction unit 25. Each component in the fluidic device 2 is arranged to correspond to one or a plurality of electrodes among electrodes included in the fluidic device 2.

The liquid droplet generation unit 21 generates a liquid droplet to be used for an analysis relating to the above-described target substance. The liquid droplet generation unit 21 includes, for example, a holding unit that holds a certain amount of liquid containing a sample or a reagent, and one or a plurality of electrodes in the vicinity of the holding unit. The holding unit will also be referred to as a reservoir. A liquid droplet is generated, for example, by dividing a portion of liquid held in the holding unit into liquid droplets using the electrowetting. The liquid droplet generation unit 21 serves as an example of a liquid droplet generation unit in the present embodiment.

The liquid droplet generation unit 21 includes, for example, a sample liquid droplet generation unit 211, a first reagent liquid droplet generation unit 212, and a second reagent liquid droplet generation unit 213.

The sample liquid droplet generation unit 211 generates a sample liquid droplet containing a sample, as a liquid droplet. The sample is, for example, a specimen, such as blood collected from a biological body, such as a patient, or a standard sample for generating standard data. The sample liquid droplet generation unit 211 serves as an example of a sample liquid droplet generation unit in the present embodiment.

The first reagent liquid droplet generation unit 212 and the second reagent liquid droplet generation unit 213 each generate a reagent liquid droplet, as a liquid droplet, containing a reagent to be used for the analysis relating to the target substance. The first reagent liquid droplet generation unit 212 and the second reagent liquid droplet generation unit 213 each serve as an example of a reagent liquid droplet generation unit in the present embodiment.

More specifically, the first reagent liquid droplet generation unit 212 generates a first reagent liquid droplet, as a reagent liquid droplet, containing a first reagent of a two-reagent system. The first reagent reacts with a predetermined component, such as a target substance contained in a standard sample and a specimen. The first reagent is a buffer solution containing bovine serum albumin (BSA) or the like, for example.

In addition, the second reagent liquid droplet generation unit 213 generates a second reagent liquid droplet, as a reagent liquid droplet, containing a second reagent that is paired with the first reagent of a two-reagent system. The second reagent is, for example, a solution containing an insoluble carrier, such as carrier particles, on which an antigen or an antibody that binds to or dissociates from a predetermined antigen or antibody contained in a sample through a specific antigen-antibody reaction is immobilized. An antigen or an antibody that bonds to or dissociates through the specific reaction may be an enzyme, a substrate, an aptamer, or a receptor.

In the above description, a case where the fluidic device 2 includes two reagent liquid droplet generation units and uses a reagent of a two-reagent system has been described. The configuration is not limited to this, and the fluidic device 2 may include one reagent liquid droplet generation unit and may use one reagent. The liquid droplet generation unit 21 may be configured by at least one of the sample liquid droplet generation unit 211, the first reagent liquid droplet generation unit 212, and the second reagent liquid droplet generation unit 213.

The liquid droplet generation unit 21 may include a mechanism of introducing an immiscible liquid that is immiscible with a liquid containing a sample or a reagent when generating a liquid droplet from the liquid containing a sample or a reagent. For example, the liquid droplet generation unit 21 dispenses a liquid droplet in such a manner that a sample liquid droplet or a reagent liquid droplet is included in a liquid droplet containing immiscible liquid. The immiscible liquid contains, for example, a component that ha a property preventing leakage of the component of the sample or the reagent. The immiscible liquid is, for example, fluorinated solvent. Examples of the fluorinated solvent include hydrofluoroether (HFE) and FC-40. In the above-described manner, by dispensing a sample liquid droplet or a reagent liquid droplet into a liquid droplet containing immiscible liquid, it is possible to prevent, for example, evaporation of a sample liquid droplet or a reagent liquid droplet and improve liquid separation of these liquid droplets. A surfactant may also be mixed when a sample liquid droplet or a reagent liquid droplet is dispensed into a liquid droplet containing immiscible liquid.

The first measurement unit 22 measures the size of a liquid droplet generated by the liquid droplet generation unit 21. The size of a liquid droplet is represented by, for example, the diameter, area, volume, and an impedance of the liquid droplet. In the present embodiment, the first measurement unit 22 includes an image acquisition unit that acquires an image of a liquid droplet. The image acquisition unit is an image sensor, such as an optical camera. The first measurement unit 22 acquires, for example, a diameter, a shape, or an area of a liquid droplet in an image from the acquired two-dimensional image of the liquid droplet. Then, the first measurement unit 22 calculates the volume of the liquid droplet using information, such as the diameter of the liquid droplet, and the height, width, or the like of a flow path of the fluidic device 2. The first measurement unit 22 may estimate the volume of the liquid droplet based on data preliminarily acquired using a sample liquid droplet containing a standard sample, for example. At least one of the acquisition of the diameter or the like of the liquid droplet, and the calculation of the volume may also be performed by the processing circuitry 4. The first measurement unit 22 serves as an example of a first measurement unit in the present embodiment.

In the present embodiment, the first measurement unit 22 measures the size of a sample liquid droplet generated by the sample liquid droplet generation unit 211, the size of a first reagent liquid droplet generated by the first reagent liquid droplet generation unit 212, and the size of a second reagent liquid droplet generated by the second reagent liquid droplet generation unit 213. In a case where the size of liquid droplets does not vary significantly for each dispensing, the measurement executed by the first measurement unit 22 may be omitted for some liquid droplets. For example, in a case where the size of first reagent liquid droplets does not vary significantly for each dispensing, the measurement executed by the first measurement unit 22 may be omitted for the first reagent liquid droplet.

The second measurement unit 23 performs measurement related to a target substance using a liquid droplet generated by the liquid droplet generation unit 21. The target substance is, for example, a nucleic acid, a protein, an endocrine material, a cell, a blood cell, a virus, a microorganism, an organic compound, an inorganic compound, or a low-molecular compound. As measurement related to the target substance, the second measurement unit 23 performs, for example, at least one of optical measurement, electrochemical measurement, and hue measurement related to the liquid droplet. In the present embodiment, the second measurement unit 23 is an optical measurement unit that performs optical measurement related to a liquid droplet. In this case, the second measurement unit 23 includes, for example, a spectrometer and measures transmittance, absorbance, fluorescence intensity, bioluminescent intensity, chemiluminescent intensity, scattered light intensity, and the like of the liquid droplet. In the optical measurement, any measurement method, such as an end point method, fixed-time method, and an initial rate method may be used in accordance with sample and reagent. The second measurement unit 23 serves as an example of a second measurement unit in the present embodiment.

The liquid discarding unit 24 discards a liquid droplet in the fluidic device 2. For example, in a case where it is determined that the size of a liquid droplet measured by the first measurement unit 22 is not within a specified range, the liquid discarding unit 24 discards the liquid droplet. The liquid discarding unit 24 also discards a liquid droplet subsequent to measurement by the second measurement unit 23.

The cleaning liquid introduction unit 25 introduces a cleaning liquid for cleaning the fluidic device 2 contaminated by an operation of the liquid droplet. The cleaning liquid is, for example, pure water, alkaline detergent, or acidic cleaner. The introduced cleaning liquid is transferred to each component of the fluidic device 2 along, for example, a flow path indicated by a solid line in the fluidic device 2 in FIG. 1. The surface of the fluidic device 2, such as the surface of a hydrophobic layer 64 and a hydrophobic layer 67 to be described below, can be accordingly cleaned. The cleaning liquid introduction unit 25 generates the cleaning liquid in the form of a liquid droplet, for example. In this case, a liquid droplet containing cleaning liquid is transferred to each component of the fluidic device 2 using the electrowetting, and each component of the fluidic device 2 is cleaned. Alternatively, the cleaning liquid introduction unit 25 may introduce flowing liquid containing cleaning liquid from the cleaning liquid introduction unit 25. In this case, by the cleaning liquid introduction unit 25 continuously or intermittently transferring cleaning liquid, each component of the fluidic device 2 is cleaned.

The fluid input-output unit 3 performs input-output of fluid to and from the fluidic device 2. The fluid input-output unit 3 includes, for example, a sample introduction unit 31, a reagent storage unit 32, a waste liquid tank unit 33, and a cleaning liquid storage unit 34.

The sample introduction unit 31 introduces a sample to be used in the fluidic device 2. The sample introduction unit 31 is connected to the sample liquid droplet generation unit 211. In the sample introduction unit 31, for example, a sample container storing a sample is disposed. The sample introduction unit 31 further includes, for example, a probe for introducing a sample from the sample container into the sample liquid droplet generation unit 211.

The reagent storage unit 32 stores a reagent, such as the first reagent and the second reagent. The reagent storage unit 32 is connected to the first reagent liquid droplet generation unit 212 and the second reagent liquid droplet generation unit 213. In the reagent storage unit 32, for example, a first reagent bottle storing the first reagent, and a second reagent bottle storing the second reagent are disposed. The reagent storage unit 32 further includes, for example, an arm for moving the first reagent bottle and the second reagent bottle to the first reagent liquid droplet generation unit 212 and the second reagent liquid droplet generation unit 213, respectively.

The waste liquid tank unit 33 is connected to the liquid discarding unit 24 and collects waste liquid collected by the liquid discarding unit 24. The waste liquid tank unit 33 includes, for example, a probe for sucking waste liquid collected by the liquid discarding unit 24. In the waste liquid tank unit 33, for example, a waste liquid bottle for collecting waste liquid is further disposed.

The cleaning liquid storage unit 34 is connected to the cleaning liquid introduction unit 25, and stores cleaning liquid to be introduced from the cleaning liquid introduction unit 25 to the fluidic device 2. In the cleaning liquid storage unit 34, for example, a cleaning liquid bottle for storing the cleaning liquid is disposed. The cleaning liquid storage unit 34 further includes, for example, a probe for introducing the cleaning liquid from the cleaning liquid bottle to the cleaning liquid introduction unit 25. The cleaning liquid storage unit 34 may be omitted. In this case, for example, the cleaning liquid bottle is disposed in the reagent storage unit 32, and the reagent storage unit 32 is connected also to the cleaning liquid introduction unit 25.

The processing circuitry 4 serves as control circuitry that controls the entire operation of the analysis apparatus 1, and also serves as calculation circuitry that performs various types of calculation. In the present embodiment, the processing circuitry 4 includes a control function 41, a determination function 42, and an analysis function 43. A dotted line illustrated in FIG. 1 indicates an example of a signal route from the processing circuitry 4.

The control function 41 is a function of comprehensively controlling each unit in the analysis apparatus 1. The control function 41 is connected to the fluidic device 2, for example, and performs an operation of a liquid droplet using the electrowetting. Specifically, by performing control of a voltage to be applied to a plurality of electrodes included in the fluidic device 2 for each electrode, the control function 41 performs the operation of a liquid droplet on an electrode. The operation of the liquid droplet may be performed in accordance with a program stored in storage circuitry (not illustrated), or may be performed by a user, such as a doctor or a laboratory technician, via an input interface (not illustrated). In addition, by controlling a drive mechanism (not illustrated), the control function 41 introduces the sample, the first reagent, and the second reagent from the sample introduction unit 31 and the reagent storage unit 32 to the sample liquid droplet generation unit 211, the first reagent liquid droplet generation unit 212, and the second reagent liquid droplet generation unit 213. The drive mechanism is implemented by a gear, a stepping motor, a belt conveyor, a lead screw, and the like. The introduction of the sample, the first reagent, and the second reagent may be performed by the user. The control function 41 also controls the first measurement unit 22 and the second measurement unit 23.

The determination function 42 determines whether, for example, the size of a liquid droplet measured by the first measurement unit 22 is within a specified range. The specified range is determined based on a conveyance limit of a liquid droplet using electrowetting, for example, and the range of a volume of the liquid droplet in which the measurement of a reagent is guaranteed. The specified range may be arbitrarily input by the user via an input interface. In addition, in a case where the size of a liquid droplet cannot be measured by the first measurement unit 22, the determination function 42 may determine that the size of the liquid droplet is not within the specified range. The determination function 42 serves as an example of a determination unit in the present embodiment.

The analysis function 43 analyzes (i.e., calculates) an amount of a target substance in a sample based on the size of the liquid droplet measured by the first measurement unit 22, and a result of measurement related to a target substance obtained by the second measurement unit 23, for example. The amount of the target substance is a concentration of the target substance in the measured liquid droplet, for example. The analysis function 43 serves as an example of an analysis unit in the present embodiment.

The analysis function 43 also corrects a result of measurement related to a target substance obtained by the second measurement unit 23, based on the size of the liquid droplet measured by the first measurement unit 22. For example, the analysis function 43 corrects a concentration of a test material contained in a sample liquid droplet from volumes of a sample liquid droplet and a reagent liquid droplet measured by the first measurement unit 22, and a value of a standard straight line. For example, the analysis function 43 corrects a result by multiplying a value obtained by optical measurement, by Va/(Va+Vb) using a volume Va of the sample liquid droplet and a volume Vb of the reagent liquid droplet that have been measured by the first measurement unit 22.

As another example, the analysis function 43 may estimate an optical path length in optical measurement that is performed by the second measurement unit 23, from the size of the liquid droplet measured by the first measurement unit 22, and use the optical path length when analyzing an amount of a target substance. Alternatively, for example, the analysis function 43 may correct the optical path length based on a predefined volume and an optical path length that are stored in the storage circuitry, and the volume of the measured liquid droplet.

As yet another example, the analysis function 43 may change a parameter of measurement that is executed by the second measurement unit 23, based on the size of the liquid droplet measured by the first measurement unit 22 and a result of measurement related to a target substance executed by the second measurement unit 23. The parameter is, for example, light intensity, a voltage, or a color tone correction value. After the parameter is changed, the analysis function 43 may cause the second measurement unit 23 to perform the measurement related to a target substance, again.

Here, for example, processing functions to be executed by the control function 41, the determination function 42, and the analysis function 43, which are components of the processing circuitry 4 illustrated in FIG. 1, are recorded in storage circuitry in the form of a computer-executable program. The processing circuitry 4 is a processor, for example. By reading out a program from the storage circuitry and executing the program, a processor included in the processing circuitry 4 implements a function corresponding to the read-out program. In other words, the processing circuitry 4 in a state in which the program has been read out includes a function illustrated in the processing circuitry 4 in FIG. 1.

While FIG. 1 illustrates a case where the control function 41, the determination function 42, and the analysis function 43 are implemented by a single piece of the processing circuitry 4, the embodiment is not limited to this. For example, the processing circuitry 4 may include a plurality of combined independent processors, and functions of these may be implemented by each processor executing a corresponding program. Alternatively, processing functions included in the processing circuitry 4 may be implemented by being appropriately dispersed or integrated into a single piece or a plurality of pieces of processing circuitry.

The output interface 5 is connected to the processing circuitry 4, and outputs a signal supplied from the processing circuitry 4. The output interface 5 is implemented by, for example, display circuitry, printing circuitry, a voice device, and the like. The display circuitry includes, for example, a cathode-ray tube (CRT) display, a liquid crystal display, an organic electroluminescence (EL) display, a light-emitting diode (LED) display, a plasma display, and the like. Processing circuitry that converts data indicating a display target into a video signal and outputs the video signal to the outside is also included in the display circuitry. The printing circuitry includes a printer or the like, for example. Output circuitry that outputs data indicating a print target, to the outside is also included in the printing circuitry. The voice device includes a speaker, for example. Output circuitry that outputs a voice signal to the outside is also included in the voice device.

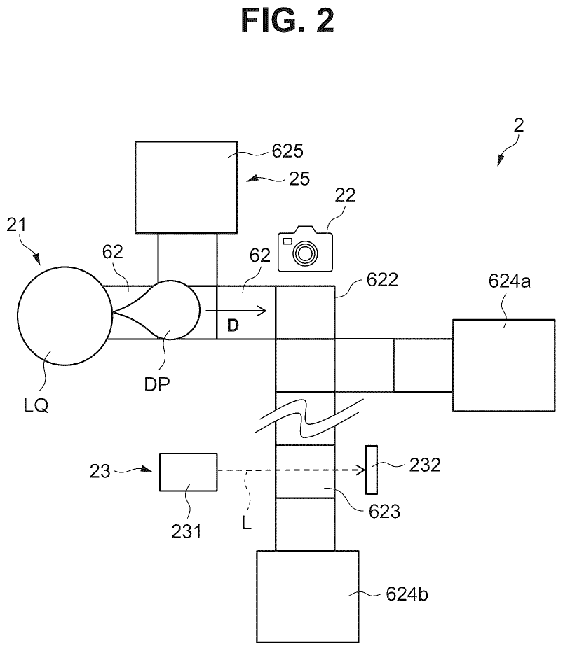

Next, a specific configuration of the fluidic device 2 according to the present embodiment will be described. FIG. 2 is a schematic plan view illustrating a configuration example of the fluidic device 2 in the analysis apparatus 1 according to the first embodiment. FIG. 2 illustrates one liquid droplet generation unit 21 as a representative of the sample liquid droplet generation unit 211, the first reagent liquid droplet generation unit 212, and the second reagent liquid droplet generation unit 213. In FIG. 2, the illustration of a dielectric layer 63, the hydrophobic layer 64, a substrate 65, an electrode 66, and the hydrophobic layer 67, which will be described below, is omitted.

As illustrated in FIG. 2, the fluidic device 2 includes a plurality of electrodes 62 for forming an electric field to be applied to a liquid droplet. The plurality of electrodes 62 is arranged along a predetermined shape, and is configured in such a manner that the liquid droplet generation unit 21, the first measurement unit 22, the second measurement unit 23, the liquid discarding unit 24, and the cleaning liquid introduction unit 25 of the fluidic device 2 function. Hereinafter, relationship between these functions and the electrodes 62 of the fluidic device 2 will be described in detail. The number, the arrangement, and the shape of electrodes 62 illustrated in FIG. 2 are examples, and the present embodiment is not limited to this.

Liquid LQ including a sample, a first reagent, or a second reagent is introduced into the holding unit of the liquid droplet generation unit 21. By at least a portion of the introduced liquid LQ being divided by one or a plurality of electrodes 62 near the holding unit, a liquid droplet DP is generated. The liquid droplet DP is moved using electrowetting in a direction indicated by a reference numeral “D”, for example.

The first measurement unit 22 is arranged to correspond to, for example, an electrode 622 among the plurality of electrodes 62. That is, the first measurement unit 22 measures the size of the liquid droplet DP on the electrode 622.

The second measurement unit 23 is arranged to correspond to, for example, an electrode 623 among the plurality of electrodes 62. That is, the second measurement unit 23 performs the measurement related to a target substance by using the liquid droplet DP on the electrode 623.

In the present embodiment, the second measurement unit 23 serving as an optical measurement unit includes a light emission unit 231 and a light receiving unit 232. The light emission unit 231 includes, for example, a white light source and a spectroscope. The light emission unit 231 emits light obtained by collimating white light from the white light source using the spectroscope, toward the liquid droplet DP on the electrode 623. The light from the light emission unit 231 passes through the inside of the liquid droplet DP along an optical path L, and is received by the light receiving unit 232. The light receiving unit 232 detects the intensity of the light. Thus, the second measurement unit 23 measures absorbance or the like of the liquid droplet DP on the electrode 623. In the example illustrated in FIG. 2, to measure transmitted light of the liquid droplet DP, a light receiving surface of the light receiving unit 232 is provided to face the light emission unit 231. The configuration of the light receiving unit 232 is not limited to this, and in the case of measuring the intensity of scattered light of the liquid droplet DP, the light receiving unit 232 may be provided at a tilt by a predetermined angle with respect to the optical path L. Alternatively, the second measurement unit 23 may measure the fluorescence intensity of the liquid droplet DP. In this case, for example, the light emission unit 231 emits excitation light to be emitted to a liquid droplet, and the light receiving unit 232 receives resultant fluorescence.

The liquid discarding unit 24 is arranged to correspond to, for example, an electrode 624a and an electrode 624b among the plurality of electrodes 62. That is, the liquid discarding unit 24 discards the liquid droplets DP on the electrode 624a and the electrode 624b. In the example illustrated in FIG. 2, the liquid droplet DP determined, as a result of measurement executed by the first measurement unit 22, to have a size not within the specified range is moved to the electrode 624a. A liquid droplet after the measurement by the second measurement unit 23 is moved to the electrode 624b.

The cleaning liquid introduction unit 25 is arranged to correspond to, for example, an electrode 625 among the plurality of electrodes 62. For example, by cleaning liquid being introduced to the electrode 625, and a portion of the introduced cleaning liquid being divided by one or a plurality of electrodes 62 near the electrode 625, a liquid droplet including cleaning liquid is generated. In the example illustrated in FIG. 2, the electrode 625 is a reservoir electrode that can hold a certain amount of cleaning liquid and dispense a portion of the cleaning liquid by electrowetting. In the cleaning liquid introduction unit 25, an injection port for injecting cleaning liquid into the fluidic device 2, or the like may be disposed in place of the electrode 625.

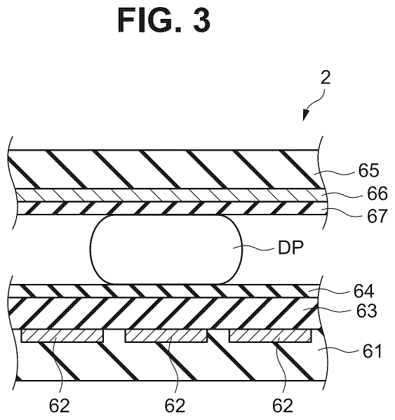

Next, a cross-sectional structure of the fluidic device 2 will be described. FIG. 3 is a cross-sectional view illustrating a configuration example of the fluidic device 2 in the analysis apparatus 1 according to the first embodiment.

As illustrated in FIG. 3, the fluidic device 2 includes, for example, a substrate 61, electrodes 62, the dielectric layer 63, the hydrophobic layer 64, the substrate 65, the electrode 66, and the hydrophobic layer 67. Among these, a flow path through which the liquid droplet DP moves is formed between the hydrophobic layer 64 and the hydrophobic layer 67.

The substrate 61 is a substrate made of materials, such as glass, a printed circuit board (PCB), and silicon. The substrate 61 is positioned below the flow path through which the liquid droplet DP moves.

A plurality of electrodes 62 is disposed on the substrate 61. The material of the electrodes 62 is, for example, copper or indium tin oxide (ITO). The electrodes 62 are each connected to, for example, a switch (not illustrated) and mutually-independent voltages are applied to the respective electrodes 62. By a voltage being applied to each of the electrodes 62, an electric field for electrowetting is formed between the electrodes 62 to which voltages are applied, and portions of the electrode 66 facing the electrodes 62. By the electric field being applied to the liquid droplet DP, the wettability of the liquid droplet DP changes. By appropriately switching an electric field to be applied to the liquid droplet DP, for example, it is possible to move the liquid droplet DP from one electrode 62 to a different electrode 62 adjacent to the one electrode 62.

The dielectric layer 63 is disposed on the electrodes 62. The material of the dielectric layer 63 is, for example, silicon nitride (Si₃N₄), parylene (registered trademark), or SU-8.

The hydrophobic layer 64 is disposed on the dielectric layer 63. As the material of the hydrophobic layer 64, for example, a water repellent coating agent containing polytetrafluoroethylene (PTFE), CYTOP (registered trademark), or the like can be applied.

Similarly to the substrate 61, the substrate 65 is a substrate containing material, such as glass, a PCB, and silicon. The substrate 65 is positioned above the flow path through which the liquid droplet DP moves. The substrate 65 may be configured to be transparent. This facilitates observation of the liquid droplet DP on the electrodes 62, measurement by the first measurement unit 22, and the like.

The electrode 66 is disposed below the substrate 65. In the present embodiment, unlike the electrodes 62, the electrode 66 is formed as one electrode. The electrode 66 is connected to a ground potential, for example. Similarly to the electrodes 62, the material of the electrode 66 is, for example, copper or ITO. In a case where ITO is used, the electrode 66 becomes a transparent electrode. This facilitates observation of the liquid droplet DP, measurement by the first measurement unit 22, and the like. The electrode 66 may be omitted at positions above at least some of the electrodes 62.

The hydrophobic layer 67 is disposed below the electrode 66. As the material of the hydrophobic layer 67, for example, a material similar to that of the hydrophobic layer 64 can be applied. Similarly to the substrate 65, the hydrophobic layer 67 may be configured to be transparent.

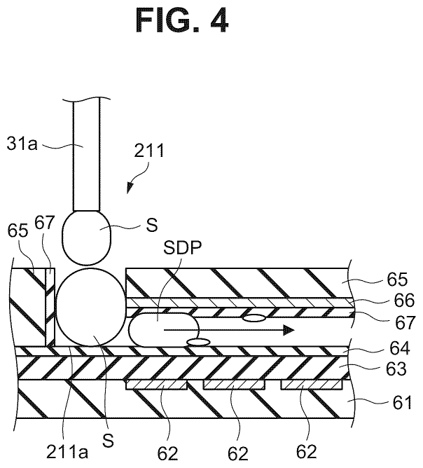

Next, the sample liquid droplet generation unit 211, the first reagent liquid droplet generation unit 212, and the second reagent liquid droplet generation unit 213 according to the present embodiment will be described with reference to FIGS. 4 to 7.

FIG. 4 is a cross-sectional view illustrating a configuration example of the sample liquid droplet generation unit 211 in the analysis apparatus 1 according to the first embodiment. As illustrated in FIG. 4, in the sample liquid droplet generation unit 211, an opening for introducing a sample S is provided in the substrate 65. FIG. 4 also illustrates a probe 31a of the sample introduction unit 31. The probe 31a is a sampling probe that can suck the sample S from the sample container, and discharge the sample S to a holding unit 211a of the sample liquid droplet generation unit 211, for example. At least a portion of the sample S introduced to the holding unit 211a is divided into a sample liquid droplet SDP by the electrode 62 in the proximity of the holding unit 211a, and moved. In the example illustrated in FIG. 4, the hydrophobic layer 67 is provided on a side surface of the opening of the substrate 65. The hydrophobic layer 67 on the side surface of the opening of the substrate 65 may be omitted.

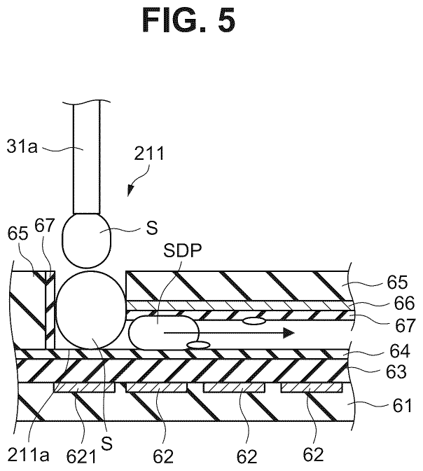

A reservoir electrode may be provided in the sample liquid droplet generation unit 211. FIG. 5 is a cross-sectional view illustrating another configuration example of the sample liquid droplet generation unit 211 in the analysis apparatus 1 according to the first embodiment. As illustrated in FIG. 5, the electrode 621 is provided as a reservoir electrode in the sample liquid droplet generation unit 211. In this case, at least a portion of the introduced sample S is divided into the sample liquid droplet SDP by the electrode 621 and another electrode 62 in the proximity of the electrode 621, and is moved.

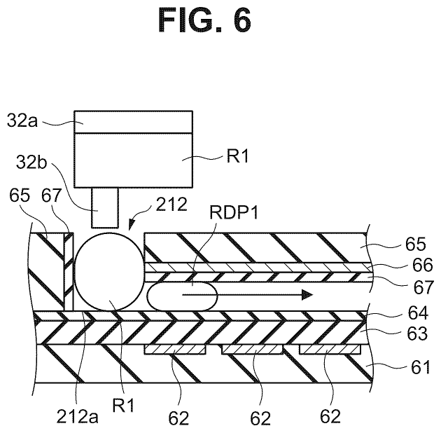

FIG. 6 is a cross-sectional view illustrating a configuration example of the first reagent liquid droplet generation unit 212 in the analysis apparatus 1 according to the first embodiment. As illustrated in FIG. 6, in the first reagent liquid droplet generation unit 212, an opening for introducing a first reagent R1 is provided in the substrate 65. FIG. 6 also illustrates a first reagent bottle 32a storing the first reagent R1. The first reagent bottle 32a is provided with, for example, an ejection unit 32b for ejecting the first reagent R1 to a holding unit 212a of the first reagent liquid droplet generation unit 212. The movement of the first reagent bottle 32a is performed by driving an arm of the reagent storage unit 32 by a drive mechanism, for example. The ejection of the first reagent R1 from the ejection unit 32b is performed by, for example, a pump included in the drive mechanism. At least a portion of the introduced first reagent R1 is divided into a first reagent liquid droplet RDP1 by the electrode 62 in the proximity of the holding unit 212a, and is moved.

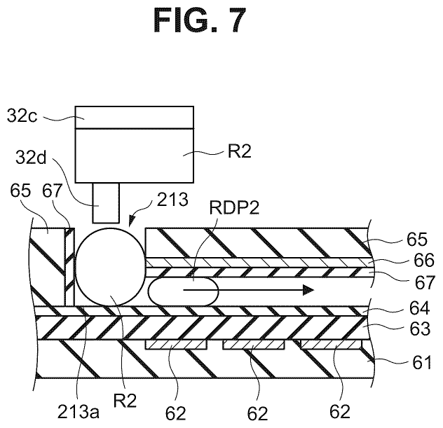

FIG. 7 is a cross-sectional view illustrating a configuration example of the second reagent liquid droplet generation unit 213 in the analysis apparatus 1 according to the first embodiment. The configuration of the second reagent liquid droplet generation unit 213 is similar to the above-described configuration of the first reagent liquid droplet generation unit 212. That is, as illustrated in FIG. 7, in the second reagent liquid droplet generation unit 213, an opening for introducing a second reagent R2 is provided in the substrate 65. FIG. 7 also illustrates a second reagent bottle 32c storing the second reagent R2. On the second reagent bottle 32c, an ejection unit 32d for ejecting the second reagent R2 to a holding unit 213a of the second reagent liquid droplet generation unit 213 is provided. The movement of the second reagent bottle 32c is performed by driving an arm of the reagent storage unit 32 by a drive mechanism, for example. The ejection of the second reagent R2 from the ejection unit 32d is performed by, for example, a pump included in the drive mechanism. At least a portion of the introduced second reagent R2 is divided into a second reagent liquid droplet RDP2 by the electrode 62 in the proximity of the holding unit 213a, and is moved.

In this manner, by introducing the sample S, the first reagent R1, and the second reagent R2 without directly contacting the fluidic device 2, the cleaning of the fluidic device 2 can be facilitated. In addition, contamination in the sample liquid droplet generation unit 211, the first reagent liquid droplet generation unit 212, and the second reagent liquid droplet generation unit 213 can be suppressed.

In the above-described example, the sample S is introduced by the sampling probe, and the first reagent R1 and the second reagent R2 are introduced by the reagent bottles with the ejection units. The introduction configuration is not limited to this, and the sample S may be introduced by a sample container having an ejection unit, and the first reagent R1 and the second reagent R2 may be introduced by a sampling probe.

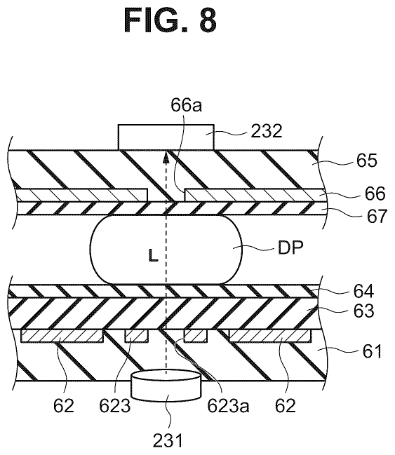

Next, an implementation example of the second measurement unit 23 according to the present embodiment will be described. FIG. 8 is a cross-sectional view illustrating a configuration example of the second measurement unit 23 in the analysis apparatus according to the first embodiment.

As illustrated in FIG. 8, the light emission unit 231 of the second measurement unit 23 is provided below the substrate 61, for example. The light receiving unit 232 of the second measurement unit 23 is provided on the substrate 65, for example. In this case, optical measurement of the liquid droplet DP on the electrode 623 is performed along the optical path L in a longitudinal direction.

In the example illustrated in FIG. 8, at least the portions of the substrate 61, the dielectric layer 63, the hydrophobic layer 64, the substrate 65, and the hydrophobic layer 67 that are located along the optical path L are configured to be transparent. In the electrode 623, an opening 623a is provided in the optical path L, and an opening 66a is provided in the electrode 66 along the optical path L. By providing the opening 623a and the opening 66a, the influence of the electrode 623 and the electrode 66 on optical measurement can be suppressed.

In the example illustrated in FIG. 8, the light emission unit 231 is provided below the substrate 61, and the light receiving unit 232 is provided on the substrate 65. The configuration is not limited to this, and the light receiving unit 232 may be provided below the substrate 61, and the light emission unit 231 may be provided on the substrate 65. Further, the direction of optical measurement is not limited to the longitudinal direction and may be any direction, such as a horizontal direction.

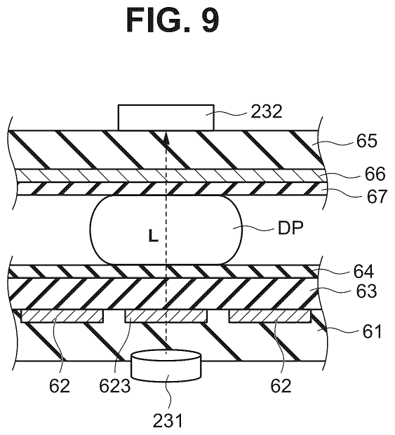

As illustrated in FIG. 9, in a case where the material of the electrode 623 and the electrode 66 is a light-transmissive material, the opening 623a and the opening 66a along the optical path L may be omitted. FIG. 9 is a cross-sectional view illustrating another implementation example of the second measurement unit 23 in the analysis apparatus 1 according to the first embodiment. In this case, for example, the processing of the electrode 623 and the electrode 66 can be facilitated.

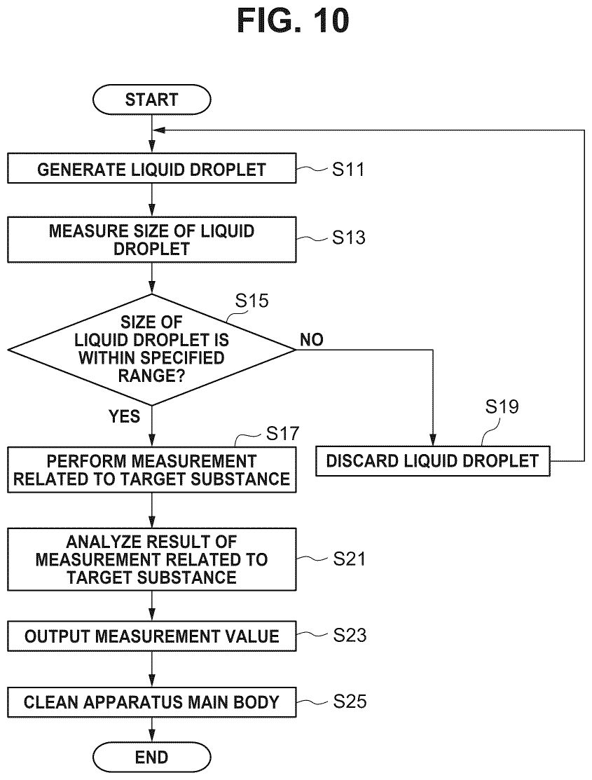

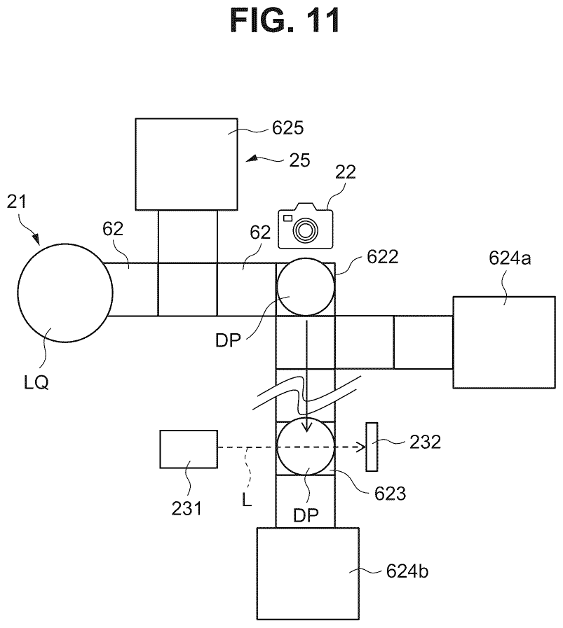

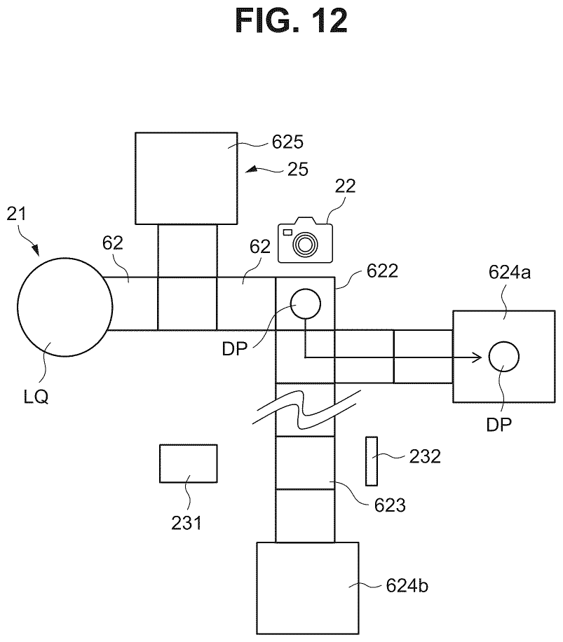

Next, an operation example of the analysis apparatus 1 according to the first embodiment that has the above-described configuration will be described with reference to FIGS. 10 to 12. FIG. 10 is a flowchart illustrating an operation example of the analysis apparatus 1 according to the first embodiment. FIGS. 11 and 12 are schematic plan views illustrating an operation example of the analysis apparatus 1 according to the first embodiment. The operation example is an operation that is executed when the user performs analysis related to a target substance included in the sample S by, for example, using the analysis apparatus 1. In the following description, in a case where there is no need to make a distinction, all of the sample liquid droplet SDP, the first reagent liquid droplet RDP1, and the second reagent liquid droplet RDP2 will be collectively referred to as the liquid droplet DP.

First of all, as illustrated in FIG. 10, in step S11, the liquid droplet DP is generated. More specifically, the control function 41 of the processing circuitry 4 causes the liquid droplet generation unit 21 to generate the liquid droplet DP. For example, in a case where the sample liquid droplet SDP is generated, first of all, the control function 41 introduces the sample S into the sample liquid droplet generation unit 211 using the probe 31a of the sample introduction unit 31 by controlling the drive mechanism. After that, the control function 41 controls a voltage to be applied to the electrode 62 in the proximity of the sample liquid droplet generation unit 211 to generate the sample liquid droplet SDP. On the other hand, in a case of generating the first reagent liquid droplet RDP1 and the second reagent liquid droplet RDP2, the control function 41 first controls the drive mechanism to introduce the first reagent liquid droplet RDP1 and the second reagent liquid droplet RDP2 from the first reagent bottle 32a and the second reagent bottle 32c into the first reagent liquid droplet generation unit 212 and the second reagent liquid droplet generation unit 213, respectively. After that, the control function 41 controls voltages to be applied to the electrodes 62 in the proximity of the first reagent liquid droplet generation unit 212 and the second reagent liquid droplet generation unit 213 to generate the first reagent liquid droplet RDP1 and the second reagent liquid droplet RDP2, respectively.

Next, in step S13, the size of the liquid droplet DP is measured. More specifically, as illustrated in FIG. 11, the control function 41 of the processing circuitry 4 controls voltages to be applied to the electrodes 62 to move the liquid droplet DP onto the electrode 622. After that, the control function 41 controls the first measurement unit 22 to cause the first measurement unit 22 to measure the size of the liquid droplet DP.

Next, as illustrated in FIG. 10, in step S15, it is determined whether the size of a liquid droplet is within a specified range. More specifically, the determination function 42 of the processing circuitry 4 determines whether the size of the liquid droplet DP that has been measured by the first measurement unit 22 is within the specified range.

In a case where the determination function 42 determines that the size of the liquid droplet DP is within a specified range (YES in step S15), the processing proceeds to step S17. In step S17, measurement related to a target substance is performed. More specifically, as illustrated in FIG. 11, the control function 41 of the processing circuitry 4 controls voltages to be applied to the electrodes 62 to move the liquid droplet DP onto the electrode 623. After that, the control function 41 controls the second measurement unit 23 to cause the second measurement unit 23 to perform measurement related to a target substance using the liquid droplet DP.

On the other hand, as illustrated in FIG. 10, in a case where the determination function 42 determines that the size of the liquid droplet DP is not within a specified range (NO in step S15), the processing proceeds to step S19. In step S19, a liquid droplet is discarded. More specifically, as illustrated in FIG. 12, the control function 41 of the processing circuitry 4 controls voltages to be applied to the electrodes 62 to move the liquid droplet DP onto the electrode 624a. In the example illustrated in FIG. 12, a case where the size of the liquid droplet DP is smaller than the specified range is illustrated. The same applies to a case where the size of the liquid droplet DP is larger than the specified range. After step S19, the processing returns to step S11, and a liquid droplet is generated again.

After step S17, in step S21, a result of the measurement related to the target substance is analyzed. More specifically, the analysis function 43 of the processing circuitry 4 analyzes an amount of the target substance in the sample S based on, for example, the size of the liquid droplet DP that has been measured by the first measurement unit 22 and a result of the measurement related to the target substance measured by the second measurement unit 23.

Next, in step S23, a measurement value is output. More specifically, the analysis function 43 of the processing circuitry 4 outputs, for example, the analyzed amount of the target substance in the sample S to the output interface 5. The output interface 5 displays, for example, the amount of the target substance.

Next, in step S25, the apparatus main body is cleaned. More specifically, the control function 41 of the processing circuitry 4 introduces cleaning liquid from the cleaning liquid introduction unit 25 into the fluidic device 2. After that, the control function 41 controls voltages to be applied to the electrodes 62 to generate a liquid droplet including cleaning liquid and moves the liquid droplet in the fluidic device 2.

Through the above-described steps, the operation of the analysis apparatus 1 in the present embodiment ends.

As described above, according to the analysis apparatus 1 in the first embodiment, the amount of the target substance in the sample S is analyzed based on the size of the liquid droplet DP that has been measured by the first measurement unit 22 and a result of the measurement related to the target substance that has been performed by the second measurement unit 23, and thus the influence on a measurement result related to the target substance due to the size of the generated liquid droplet DP can be reduced. Consequently, the accuracy of an analysis result in the analysis apparatus 1 can be improved.

By correcting a result of the measurement related to the target substance that has been performed by the second measurement unit 23, based on the size of the liquid droplet DP that has been measured by the first measurement unit 22, a variation in results of the measurement related to the target substance due to a variation in the size of the generated liquid droplet DP can also be reduced.

Further, in a case where it is determined that the measured size of the liquid droplet DP is not within the specified range, the liquid droplet DP is discarded, and consequently measurement on a liquid droplet of which the size is not within the specified range can be avoided. Consequently, the throughput of the analysis apparatus 1 can be improved. Furthermore, in a case where the sample liquid droplet SDP and a reagent liquid droplet are mixed and reacted, consumption of a reagent is avoided, which reduces cost of the test.

### Modified Example 1 of First Embodiment

In the above-described first embodiment, the first measurement unit 22 includes an image acquisition unit that acquires an image of the liquid droplet DP. In Modified Example 1 of the first embodiment to be described below, the first measurement unit 22 includes an impedance acquisition unit for acquiring an impedance of the liquid droplet DP. Hereinafter, Modified Example 1 of the first embodiment will be described mainly based on a difference from the first embodiment.

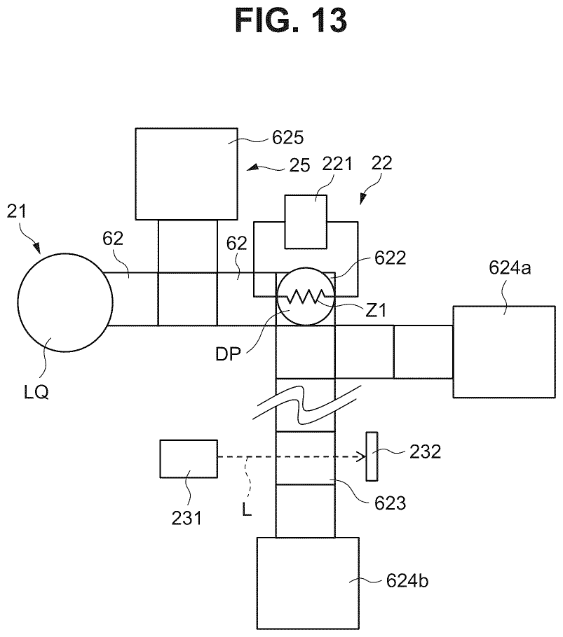

FIG. 13 is a schematic plan view illustrating a configuration example of the fluidic device 2 in the analysis apparatus 1 according to Modified Example 1 of the first embodiment. As illustrated in FIG. 13, the first measurement unit 22 according to the present modified example includes an impedance sensor 221 as an impedance acquisition unit. The first measurement unit 22 is electrically connected to the impedance sensor 221 and includes wiring 222 that comes into contact with the liquid droplet DP in the electrode 622, for example. The first measurement unit 22 measures an impedance Z1 of the liquid droplet DP on the electrode 622 by using the impedance sensor 221 and the wiring 222. The impedance Z1 can be an electrostatic capacitance or the like of the liquid droplet DP. The first measurement unit 22 may calculate a volume of the liquid droplet DP by using the impedance Z1 of the liquid droplet DP.

According to this modified example, the method for measuring the size of the liquid droplet DP can be expanded. The impedance acquisition unit may also be used in combination with the above-described image acquisition unit.

### Modified Example 2 of First Embodiment

In the above-described first embodiment, the second measurement unit 23 performs optical measurement. In Modified Example 2 of the first embodiment to be described below, the second measurement unit 23 performs an electrochemical measurement. Hereinafter, Modified Example 2 of the first embodiment will be described mainly based on a difference from the first embodiment.

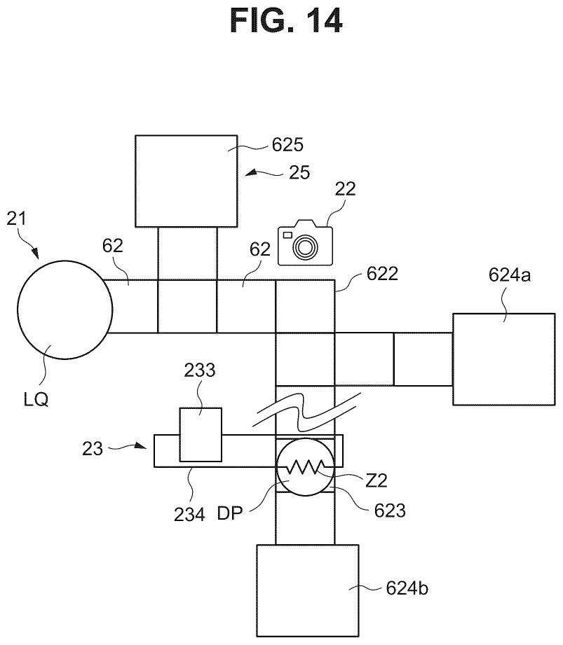

FIG. 14 is a schematic plan view illustrating a configuration example of the fluidic device 2 in the analysis apparatus 1 according to Modified Example 2 of the first embodiment. As illustrated in FIG. 14, the second measurement unit 23 according to the present modified example includes, for example, an impedance sensor 233 that acquires an impedance, and wiring 234 that is electrically connected to the impedance sensor 233 and comes into contact with the liquid droplet DP in the electrode 623. The second measurement unit 23 acquires an impedance Z2 of the liquid droplet DP on the electrode 623 by using the impedance sensor 233 and the wiring 234. Then, the second measurement unit 23 calculates, for example, a concentration of the target substance included in the liquid droplet DP by using the impedance Z2 of the liquid droplet DP.

According to this modified example, the method of measurement related to a target substance that uses the liquid droplet DP can be expanded. The second measurement unit 23 may measure a potential difference generated in the liquid droplet DP or the like in place of the impedance Z2 of the liquid droplet DP.

### Modified Example 3 of First Embodiment

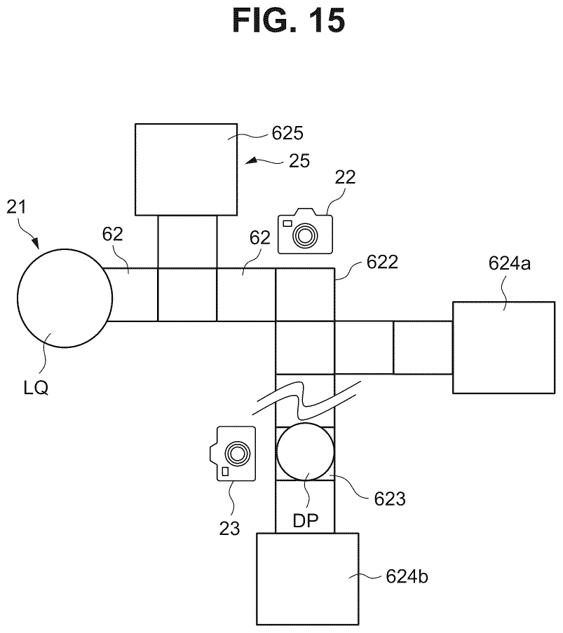

Next, Modified Example 3 of the first embodiment in which the second measurement unit 23 performs a hue measurement will be described. FIG. 15 is a schematic plan view illustrating a configuration example of the fluidic device 2 in the analysis apparatus 1 according to Modified Example 3 of the first embodiment.

As illustrated in FIG. 15, the second measurement unit 23 according to the present modified example includes an image sensor for performing the hue measurement. The second measurement unit 23 measures a hue of the liquid droplet DP in the electrode 623.

According to this modified example, the method of measurement related to a target substance that uses the liquid droplet DP can be diversified. The second measurement unit 23 may measure the intensity of bioluminescence or chemiluminescence of the liquid droplet DP by using the image sensor.

### Modified Example 4 of First Embodiment

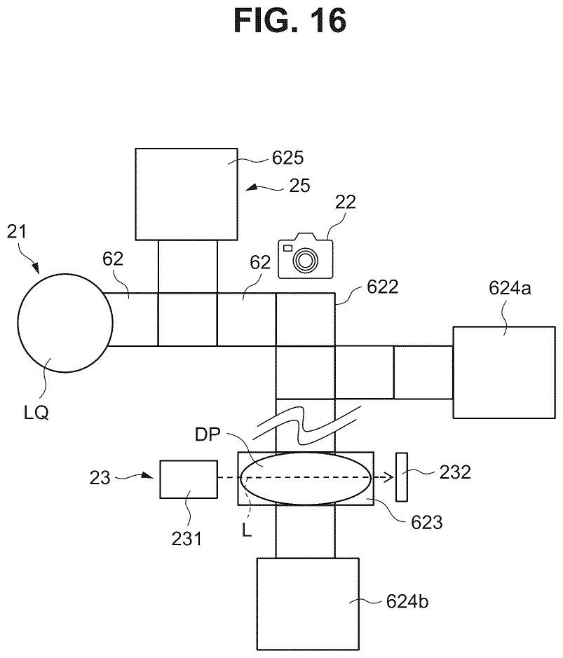

Modified Example 4 of the first embodiment in which the second measurement unit 23 has a structure configured to increase an optical path length in the above-described first embodiment will be described. FIG. 16 is a schematic plan view illustrating a configuration example of the fluidic device 2 in the analysis apparatus 1 according to Modified Example 4 of the first embodiment.

As illustrated in FIG. 16, a distance between the light emission unit 231 and the light receiving unit 232 in the second measurement unit 23 according to the present modified example is larger than a distance between the light emission unit 231 and the light receiving unit 232 in the second measurement unit 23 according to the first embodiment. In addition, in the present modified example, the electrode 623 has a horizontally long shape. The liquid droplet DP positioned in the electrode 623 is horizontally extended in accordance with the shape of the electrode 623. Accordingly, the optical path L of light from the light emission unit 231 to the light receiving unit 232 becomes longer.

According to the present modified example, in a case where an increased optical path length is desirable, such as a case of measuring transmitted light of the liquid droplet DP, measurement related to a target substance can be performed more appropriately.

### Modified Example 5 of First Embodiment

In the above-described first embodiment, in a case where it is determined that the size of the liquid droplet DP is not within the specified range, the liquid droplet DP is discarded. In Modified Example 5 of the first embodiment to be described below, a function is provided to supplement or divide the liquid droplet DP in a case where it is determined that the size of the liquid droplet DP is not within the specified range. Hereinafter, Modified Example 5 of the first embodiment will be described mainly based on a difference from the first embodiment.

In the present modified example, in a case where it is determined that the size of the liquid droplet DP is smaller than the specified range, the liquid droplet generation unit 21 further generates a supplement liquid droplet DPR for supplementing the liquid droplet DP. The supplement liquid droplet DPR is generated by the liquid droplet generation unit 21 by a method similar to that of the liquid droplet DP, for example.

Further, in the present modified example, a dividing unit is provided to divide the liquid droplet DP into a plurality of liquid droplets with a size smaller than that of the liquid droplet DP by application of an electric field in a case where it is determined that the size of the liquid droplet DP is larger than the specified range. The dividing unit includes, for example, the electrode 622 and the electrode 62 adjacent to the electrode 622.

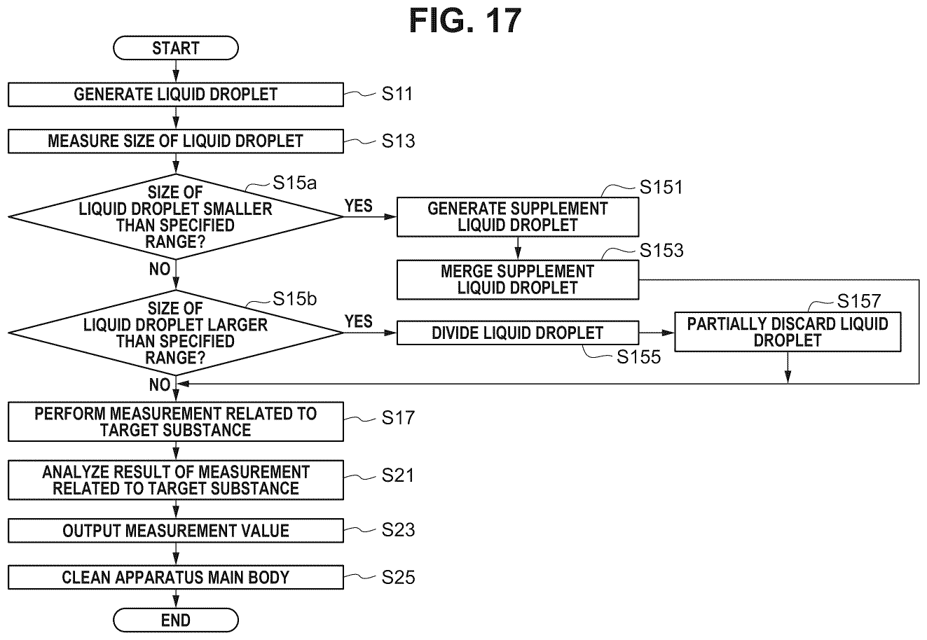

FIG. 17 is a flowchart illustrating an operation example of the analysis apparatus 1 according to Modified Example 5 of the first embodiment. As illustrated in FIG. 17, in step S15a, after step S13, it is determined whether the size of the liquid droplet DP is smaller than the specified range. More specifically, the determination function 42 of the processing circuitry 4 determines whether the size of the liquid droplet DP that has been measured by the first measurement unit 22 is smaller than the specified range.

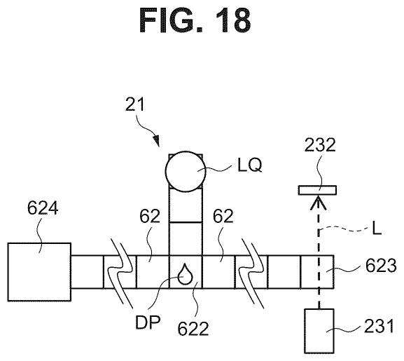

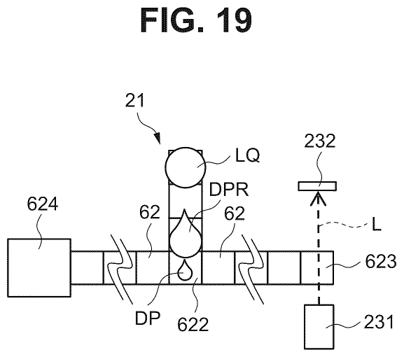

In a case where the determination function 42 determines that the size of the liquid droplet DP is smaller than the specified range (YES in step S15a), the processing proceeds to step S151. In step S151, the supplement liquid droplet DPR is generated. More specifically, as illustrated in FIG. 18, in a case where it is determined that the size of the liquid droplet DP on the electrode 622 in the first measurement unit 22 is smaller than the specified range, as illustrated in FIG. 19, the control function 41 of the processing circuitry 4 causes the liquid droplet generation unit 21 to generate the supplement liquid droplet DPR to supplement the liquid droplet DP.

As illustrated in FIG. 17, after step S151, in step S153, the supplement liquid droplet DPR is merged. More specifically, the control function 41 of the processing circuitry 4 controls voltages to be applied to the electrodes 62, to move the supplement liquid droplet DPR to the electrode 622, and merges the supplement liquid droplet DPR with the liquid droplet DP. After step S153, processing in step S17 and subsequent steps is performed similarly to the first embodiment. That is, using a liquid droplet obtained by merging the supplement liquid droplet DPR with the liquid droplet DP, measurement related to a target substance is performed. A liquid droplet obtained by merging the supplement liquid droplet DPR with the liquid droplet DP may be discarded. In this case, the supplement liquid droplet DPR may be a liquid droplet including cleaning liquid.

On the other hand, in step S15a, in a case where it is determined that the size of the liquid droplet DP is not smaller than the specified range (NO in step S15a), the processing proceeds to step S15b. In step S15b, it is determined whether the size of the liquid droplet DP is larger than the specified range. More specifically, the determination function 42 of the processing circuitry 4 determines whether the size of the liquid droplet DP that has been measured by the first measurement unit 22 is larger than the specified range.

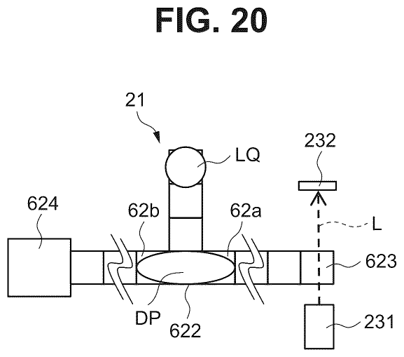

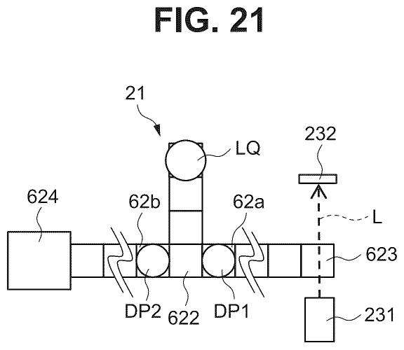

In a case where it is determined that the size of the liquid droplet DP is larger than the specified range (YES in step S15b), the processing proceeds to step S155. In step S155, the liquid droplet DP is divided. More specifically, as illustrated in FIG. 20, in a case where it is determined that the size of the liquid droplet DP is larger than the specified range, the control function 41 of the processing circuitry 4 controls voltages to be applied to the electrodes 62 to stretch the liquid droplet DP onto a plurality of electrodes 62. More specifically, by applying voltages to the electrode 622, and an electrode 62a and an electrode 62b adjacent to the electrode 622, the control function 41 stretch the liquid droplet DP onto the electrode 622, the electrode 62a, and the electrode 62b. After that, as illustrated in FIG. 21, the control function 41 maintains the voltage applied to the electrode 62a and the electrode 62b while removing the voltage from the electrode 622. As a result, the liquid droplet DP is divided into a plurality of liquid droplets DP1 and DP2 with a size smaller than that of the liquid droplet DP. The electrode 622, the electrode 62a, and the electrode 62b serve as an example of a dividing unit in the present modified example. That is, the electrode 622, the electrode 62a, and the electrode 62b divide the liquid droplet DP into a plurality of liquid droplets with a size smaller than that of the liquid droplet DP by the application of an electric field.

As illustrated in FIG. 17, after step S155, in step S157, a liquid droplet is partially discarded. More specifically, as illustrated in FIG. 21, the control function 41 of the processing circuitry 4 controls, for example, voltages to be applied to the electrodes 62 to move the liquid droplet DP2 on the electrode 62b to the electrode 624 where the liquid discarding unit 24 is positioned. After step S157, processing in step S17 and subsequent steps is performed similarly to the first embodiment. More specifically, the control function 41 controls, for example, voltages to be applied to the electrodes 62 to move the liquid droplet DP1 on the electrode 62a to the electrode 623 where the second measurement unit 23 is positioned. Then, using the liquid droplet DP1, measurement related to a target substance is performed. Both of the liquid droplet DP1 and the liquid droplet DP2 may be discarded.

According to this modified example, the liquid droplet DP having the size outside the specified range can also be used for measurement by the second measurement unit 23. Thus, an amount of the sample S to be discarded can be reduced.

In general, in a DMF device, in some cases, a portion of the liquid droplet DP may remain during generation and movement of the liquid droplet DP, and the liquid droplet DP may unintentionally merge with another liquid droplet. When a portion of the liquid droplet DP remains, the residual liquid droplet DP may be too small to be moved using electrowetting. Similarly, an unintentionally merged liquid droplet may also be of a size that cannot be moved using electrowetting. According to the present modified example, in such a case, such residual portions of the liquid droplet DP and/or merged liquid droplets can be moved.

In the above description, a case where functions of both the generation of the supplement liquid droplet DPR and division of the liquid droplet DP has been described. The case is not limited to this, and the analysis apparatus 1 may include either one of the functions of generating the supplement liquid droplet DPR and the function of dividing the liquid droplet DP.

Further, the generation of the supplement liquid droplet DPR, and the division of the liquid droplet DP may be combined with the determination of whether the size is within the specified range. For example, a first range and a second range different from the first range are defined as specified ranges. Then, in a case where the size of the liquid droplet DP is smaller than the first range and is within the second range, the supplement liquid droplet DPR may be generated, in a case where the size of the liquid droplet DP is larger than the first range and is within the second range, the liquid droplet DP may be divided, and in a case where the size of the liquid droplet DP does not fall within the second range, the liquid droplet DP may be discarded.

### Second Embodiment

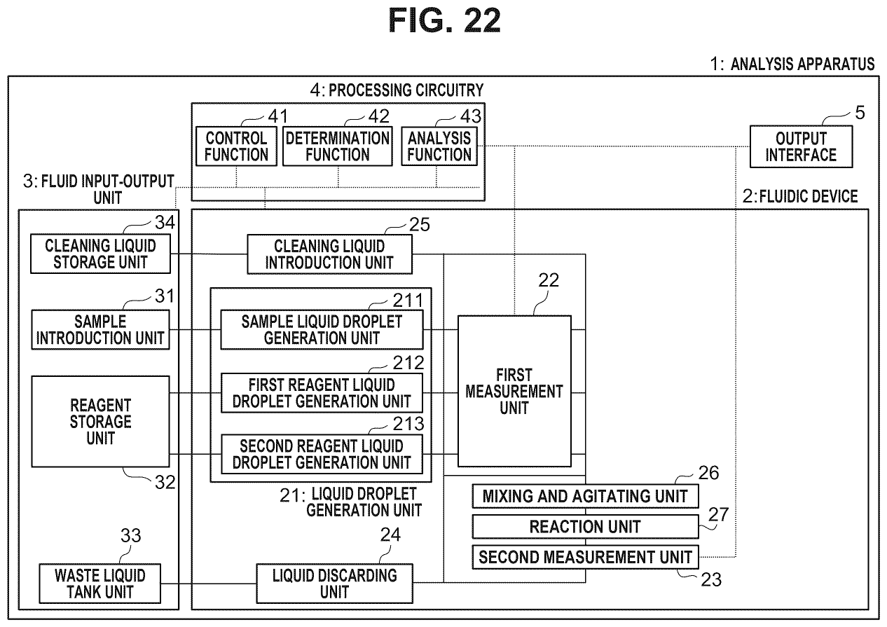

Next, a second embodiment in which a region in which the liquid droplet DP is mixed, agitated, and reacted is provided in the analysis apparatus 1 according to the first embodiment will be described. FIG. 22 is a block diagram illustrating a configuration example of an analysis apparatus 1 according to the second embodiment. Hereinafter, the present embodiment will be described mainly based on a difference from the first embodiment.

As illustrated in FIG. 22, a fluidic device 2 according to the present embodiment further includes a mixing and agitating unit 26 and a reaction unit 27. Both of the mixing and agitating unit 26 and the reaction unit 27 are regions formed by one or a plurality of electrodes 62.

The mixing and agitating unit 26 mixes and agitates a plurality of liquid droplets DP using electrowetting. For example, the mixing and agitating unit 26 mixes and agitates the sample liquid droplet SDP generated by the sample liquid droplet generation unit 211, and the first reagent liquid droplet RDP1 generated by the first reagent liquid droplet generation unit 212. Further, the mixing and agitating unit 26 mixes and agitates a mixed liquid droplet obtained by mixing the sample liquid droplet SDP and the first reagent liquid droplet RDP1, and the second reagent liquid droplet RDP2 generated by the second reagent liquid droplet generation unit 213.

The reaction unit 27 reacts the mixed liquid droplet of the sample liquid droplet SDP and the reagent liquid droplet. For example, the reaction unit 27 holds the mixed liquid droplet, and allows a chemical reaction to occur in the mixed liquid droplet. The chemical reaction is, for example, a reaction between the sample S and the first reagent R1 in the mixed liquid droplet obtained by mixing the sample liquid droplet SDP and the first reagent liquid droplet RDP1.

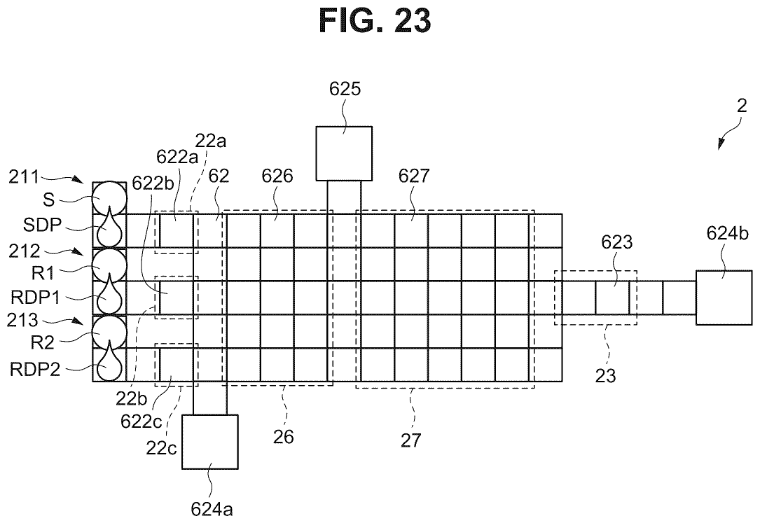

Next, a specific configuration of the fluidic device 2 according to the present embodiment will be described. FIG. 23 is a schematic plan view illustrating a configuration example of the fluidic device 2 in the analysis apparatus 1 according to the second embodiment.

As illustrated in FIG. 23, in the present embodiment, the sample liquid droplet generation unit 211, the first reagent liquid droplet generation unit 212, and the second reagent liquid droplet generation unit 213 are provided as the liquid droplet generation unit 21. Further, a first measurement unit 22a for measuring the size of the sample liquid droplet SDP, a first measurement unit 22b for measuring the size of the first reagent liquid droplet RDP1, and a first measurement unit 22c for measuring the size of the second reagent liquid droplet RDP2 are provided as the first measurement unit 22. The first measurement units 22a, 22b, and 22c are arranged to correspond to electrodes 622a, 622b, and 622c among the plurality of electrodes 62, respectively.

The mixing and agitating unit 26 is arranged to correspond to electrodes 626 among the plurality of electrodes 62. The liquid droplet DP of which the size has been measured by the first measurement unit 22 is moved to an electrode 626, and mixed and agitated. In the example illustrated in FIG. 23, a plurality of electrodes 626 is provided. When liquid droplets are mixed, for example, after two liquid droplets DP are moved onto adjacent electrodes 626, the application of voltage to either one of the electrodes 626 is stopped. When liquid droplets are agitated, a mixed liquid droplet is moved on the electrodes 626. For example, the mixed liquid droplet is reciprocated between adjacent electrodes 626, or the mixed liquid droplet is rotated within a 2× 2 array of electrodes 626.

The reaction unit 27 is arranged to correspond to electrodes 627 among the plurality of electrodes 62. The mixed liquid droplet mixed and agitated by the mixing and agitating unit 26 is moved to the electrode 627, and held for a fixed time sufficient for a reaction. This allows a chemical reaction to proceed within the mixed liquid droplet. It may be sufficient that at least one electrode 627 is provided. On the other hand, in the example illustrated in FIG. 23, a plurality of electrodes 627 is provided. This enables, for example, simultaneous progression of reactions in a plurality of mixed liquid droplets.

A mixed liquid droplet in which a chemical reaction has been performed by the reaction unit 27 is moved to the electrode 623 where measurement is performed by the second measurement unit 23. It may also be possible that, after the measurement performed by the second measurement unit 23, the mixed liquid droplet is returned to the reaction unit 27.

In addition, at least some of the electrodes 62 in the mixing and agitating unit 26 and the reaction unit 27 may be shared. For example, the reaction unit 27 may be provided in the same region as the mixing and agitating unit 26. In such a case, a process of moving an agitated mixed liquid droplet to the reaction unit 27 can be omitted. Alternatively, the second measurement unit 23 may be provided in the same region as at least a part of the reaction unit 27. In this case, a process of moving a mixed liquid droplet in which a chemical reaction has been performed, to the second measurement unit 23 can be omitted.

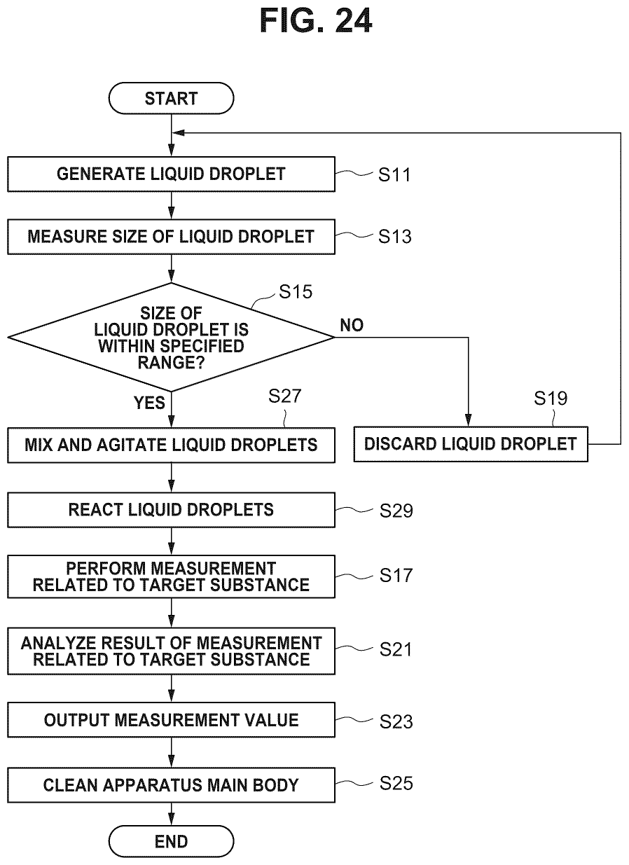

Next, an operation example of the analysis apparatus 1 according to the second embodiment that has the above-described configuration will be described with reference to FIG. 24. FIG. 24 is a flowchart illustrating an operation example of the analysis apparatus 1 according to the second embodiment. In the following description, unless otherwise necessary for distinction, the sample liquid droplet SDP, the first reagent liquid droplet RDP1, the second reagent liquid droplet RDP2, and mixed liquid droplet will be referred to as the liquid droplet DP.

In the present embodiment, in step S11, the sample liquid droplet SDP, the first reagent liquid droplet RDP1, and the second reagent liquid droplet RDP2 are generated. Next, in step S13, the sizes of the sample liquid droplet SDP, the first reagent liquid droplet RDP1, and the second reagent liquid droplet RDP2 that have been generated are measured. Next, in step S15, it is determined whether the sizes of the sample liquid droplet SDP, the first reagent liquid droplet RDP1, and the second reagent liquid droplet RDP2 are within the respective specified range. In a case where it is determined that the sizes are not within the specified range (NO in step S15), the processing proceeds to step S19. In step S19, the sample liquid droplet SDP, the first reagent liquid droplet RDP1, and the second reagent liquid droplet RDP2 are moved to the electrode 624a illustrated in FIG. 23, and discarded by the liquid discarding unit 24. After that, in step S11, a liquid droplet is generated again. In the present embodiment, as for a liquid droplet of which the size is determined to be within the specified range, the regeneration of a liquid droplet may be omitted.

On the other hand, in a case where it is determined that the size is within the specified range (YES in step S15), the processing proceeds to step S27. In step S27, the liquid droplets DP are mixed and agitated. More specifically, the control function 41 of the processing circuitry 4 controls, for example, voltages to be applied to the electrodes 62 to move the sample liquid droplet SDP and the first reagent liquid droplet RDP1 onto different electrodes 626. After that, the control function 41 controls voltages to be applied to the electrodes 62 to mix the sample liquid droplet SDP and the first reagent liquid droplet RDP1 into one mixed liquid droplet. After that, the control function 41 controls voltages to be applied to the electrodes 62 to agitate the mixed liquid droplet. After that, by a similar method, the control function 41 mixes the mixed liquid droplet with the second reagent liquid droplet RDP2, and agitates a resultant mixed liquid droplet.

Next, in step S29, the liquid droplets DP are reacted. More specifically, the control function 41 of the processing circuitry 4 controls voltages to be applied to the electrodes 62 to move a mixed liquid droplet of the sample liquid droplet SDP, the first reagent liquid droplet RDP1, and the second reagent liquid droplet RDP2 onto the electrode 627. After that, the control function 41 holds the mixed liquid droplet on the electrode 627 for a time sufficient for a reaction. Then, in step S17, measurement related to the target substance is performed using the mixed liquid droplet.

Subsequent steps are similar to those in the first embodiment.

According to the present embodiment, a region for mixing and agitating the liquid droplets DP is allocated, whereby mixing and agitating are facilitated. In addition, a region for reacting a mixed liquid droplet is allocated, allowing sufficient time for the chemical reaction to occur within the mixed liquid droplet.

### Third Embodiment

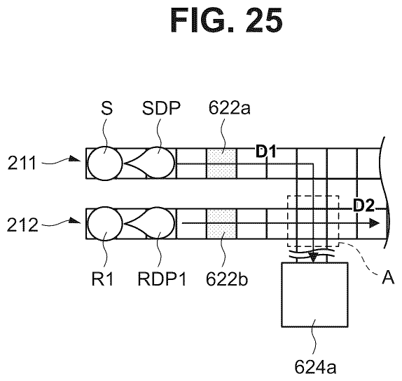

In the above-described second embodiment, after the size of the liquid droplet DP is measured, the sample liquid droplet SDP, the first reagent liquid droplet RDP1, and the second reagent liquid droplet RDP2 are moved to the same electrode 624a, and discarded by the liquid discarding unit 24. In this case, there is a possibility of contamination occurring due to the intersection of the flow path of liquid droplets to be discarded and the flow path of liquid droplets to be moved to the second measurement unit 23. This will be described with reference to FIG. 25. FIG. 25 is a schematic diagram illustrating the contamination in the analysis apparatus 1 according to the second embodiment.

In FIG. 25, an example case is illustrated in which the size of the sample liquid droplet SDP is not within the specified range, whereas the size of the first reagent liquid droplet RDP1 is within the specified range. In this case, the sample liquid droplet SDP is moved from the electrode 622a to an electrode 642a along a flow path D1. On the other hand, the first reagent liquid droplet RDP1 is moved from the electrode 622b to the mixing and agitating unit 26, the reaction unit 27, and the second measurement unit 23 along a flow path D2. Here, the flow path D1 and the flow path D2 intersect with each other in a region A. In such a case, there is a possibility that a portion of the sample liquid droplet SDP, which is planned to be discarded, remains in the region A, and the first reagent liquid droplet RDP1 may be contaminated.

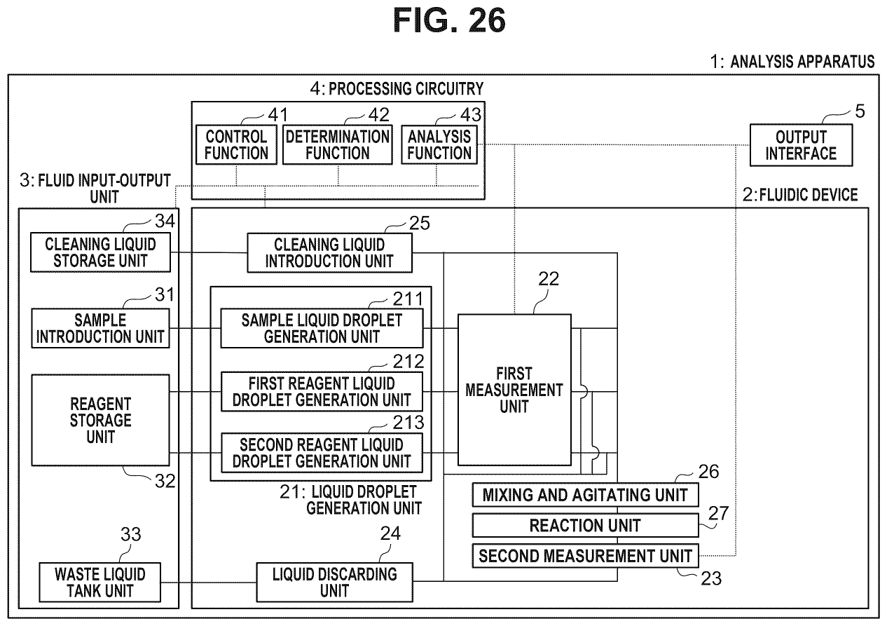

Therefore, in a third embodiment to be described below, an analysis apparatus 1 is configured in such a manner that a flow path of the liquid droplet DP to be discarded does not intersect with a flow path of the liquid droplet DP to be moved to the second measurement unit 23. FIG. 26 is a block diagram illustrating a configuration example of the analysis apparatus 1 according to the third embodiment. Hereinafter, the following description focuses on the differences between the present embodiment and the second embodiment.

As illustrated in FIG. 26, a flow path included in the configuration of the present embodiment is a flow path for transferring the liquid droplet DP to the liquid discarding unit 24 without passing through a flow path leading to the second measurement unit 23 in a case where it is determined that the size of the liquid droplet DP that has been measured by the first measurement unit 22 is not within the specified range. For example, a flow path along which the sample liquid droplet SDP, whose size has been measured by the first measurement unit 22, is moved to the liquid discarding unit 24 does not intersect with a flow path along which the first reagent liquid droplet RDP1 and the second reagent liquid droplet RDP2 are moved to the mixing and agitating unit 26. Further, a flow path along which the first reagent liquid droplet RDP1, whose size has been measured by the first measurement unit 22, is moved to the liquid discarding unit 24 does not intersect with a flow path along which the sample liquid droplet SDP and the second reagent liquid droplet RDP2 are moved to the mixing and agitating unit 26. Furthermore, a flow path along which the second reagent liquid droplet RDP2, whose size has been measured by the first measurement unit 22, is moved to the liquid discarding unit 24 does not intersect with a flow path along which the sample liquid droplet SDP and the first reagent liquid droplet RDP1 are moved to the mixing and agitating unit 26.

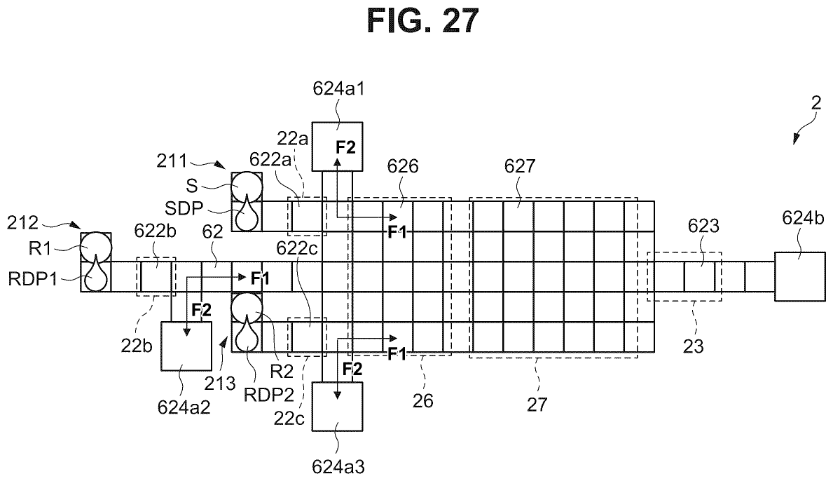

Hereinafter, a specific configuration of such a flow path will be described with reference to FIG. 27. FIG. 27 is a schematic plan view illustrating a configuration example of the fluidic device 2 in the analysis apparatus 1 according to the third embodiment.

As illustrated in FIG. 27, the fluidic device 2 according to the present embodiment includes separate electrodes in the liquid discarding unit 24 for the sample liquid droplet SDP, the first reagent liquid droplet RDP1, and the second reagent liquid droplet RDP2, respectively. That is, in a case where it is determined that the size of each liquid droplet is not within the specified range, the sample liquid droplet SDP is moved to an electrode 624a1, the first reagent liquid droplet RDP1 is moved to an electrode 624a2, and the second reagent liquid droplet RDP2 is moved to an electrode 624a3. For example, the sample liquid droplet SDP, whose size has been determined to be not within the specified range, is moved to the electrode 626 along a first flow path F1. On the other hand, the sample liquid droplet SDP whose size has been determined to be not within the specified range is moved to the electrode 624al along a second flow path F2. The liquid discarding unit 24 discards the liquid droplets DP on the electrode 624al, the electrode 624a2, and the electrode 624a3.

As described above, in the present embodiment, a plurality of electrodes 62 in the fluidic device 2 includes the first flow path F1 and the second flow path F2. The first flow path F1 is a flow path along which the liquid droplet DP measured by the first measurement unit 22 is moved to cause the second measurement unit 23 to measure the liquid droplet DP. The second flow path F2 is a flow path different from the first flow path F1 and is used to move the liquid droplet DP measured by the first measurement unit 22 to the liquid discarding unit 24.

As described above, according to the present embodiment, it is possible to suppress the occurrence of contamination in the fluidic device 2.

### Fourth Embodiment

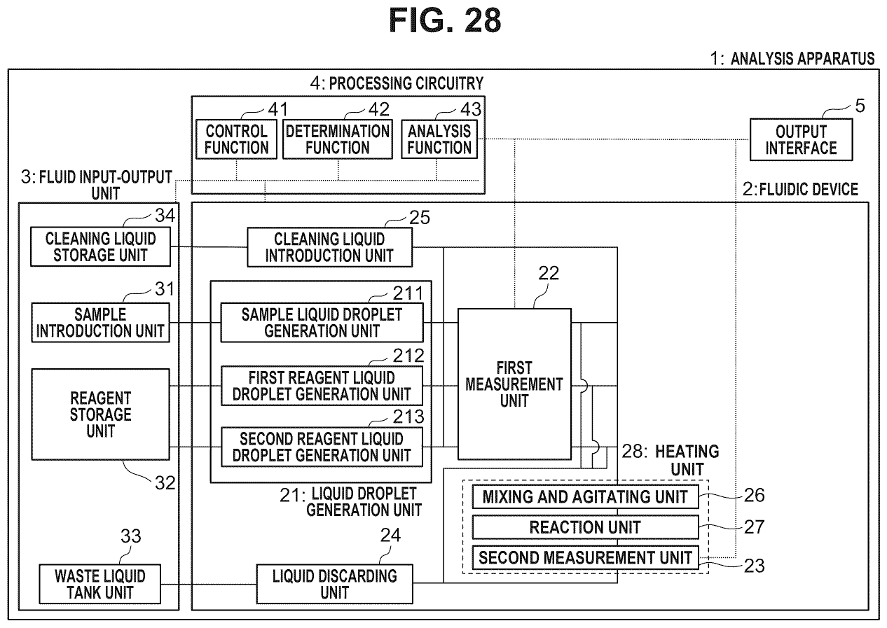

Next, a fourth embodiment including a function of heating the liquid droplet DP in the fluidic device 2 will be described. FIG. 28 is a block diagram illustrating a configuration example of an analysis apparatus 1 according to the fourth embodiment. Hereinafter, the following description focuses on the differences between the present embodiment and the third embodiment.

As illustrated in FIG. 28, a fluidic device 2 according to the present embodiment further includes a heating unit 28. The heating unit 28 heats the liquid droplet DP in the fluidic device 2. The heating unit 28 is, for example, an electrically-heated wire provided below the electrodes 62. In the present embodiment, the heating unit 28 is provided in the mixing and agitating unit 26, the reaction unit 27, and the second measurement unit 23, and heats the liquid droplets DP positioned on the electrodes 62 in these units. A temperature for heating the liquid droplet DP is, for example, 37° C.

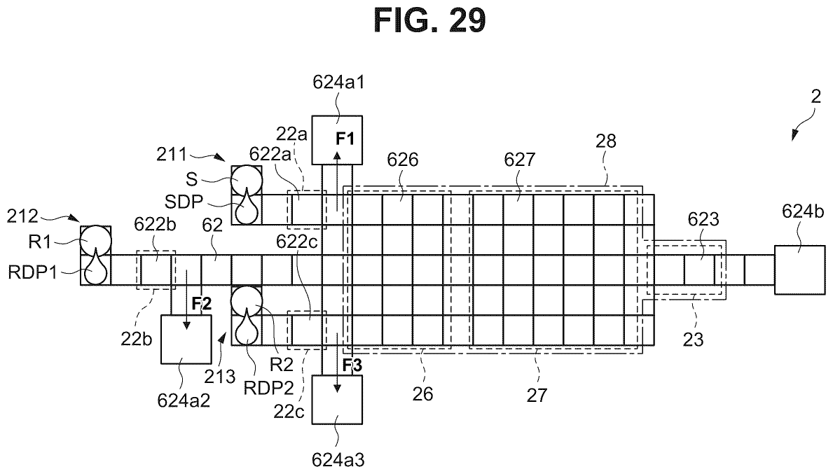

Hereinafter, a specific configuration of the heating unit 28 will be described with reference to FIG. 29. FIG. 29 is a schematic plan view illustrating a configuration example of the fluidic device 2 in the analysis apparatus 1 according to the fourth embodiment. In the example illustrated in FIG. 29, the heating unit 28 is provided below the electrodes 62 where the mixing and agitating unit 26, the reaction unit 27, and the second measurement unit 23 are disposed.

The heating unit 28 may be provided in at least one of the mixing and agitating unit 26, the reaction unit 27, and the second measurement unit 23. Further, the heating unit 28 may uniformly heat the reaction unit 27 and the second measurement unit 23. This allows the second measurement unit 23 to perform measurement related to the target substance under the same temperature condition as the reaction unit 27. Furthermore, the heating unit 28 may also be provided in the first measurement unit 22.

According to the present embodiment, by heating the liquid droplet DP using the heating unit 28, it is possible to promote, for example, a reaction in a mixed liquid droplet.

### Fifth Embodiment

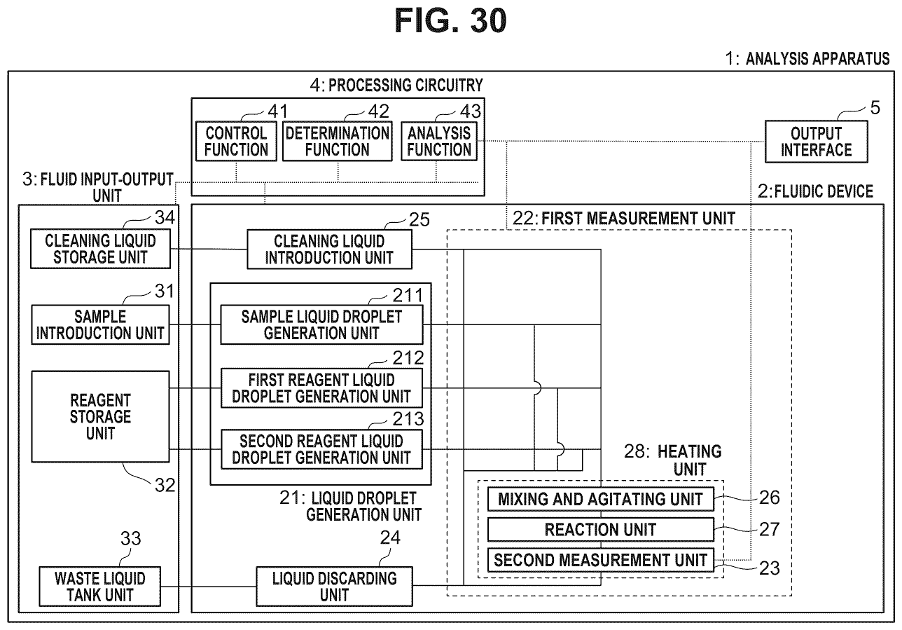

A fifth embodiment in which the first measurement unit 22 is configured to monitor the entire flow path of the fluidic device 2 in the above-described fourth embodiment will be described. FIG. 30 is a block diagram illustrating a configuration example of an analysis apparatus 1 according to the fifth embodiment.

As illustrated in FIG. 30, in the present embodiment, the first measurement unit 22 measures the sizes of the liquid droplets DP positioned in the mixing and agitating unit 26, the reaction unit 27, and the second measurement unit 23, for example, in addition to the size of the liquid droplet DP immediately after the liquid droplet DP is generated by the liquid droplet generation unit 21.

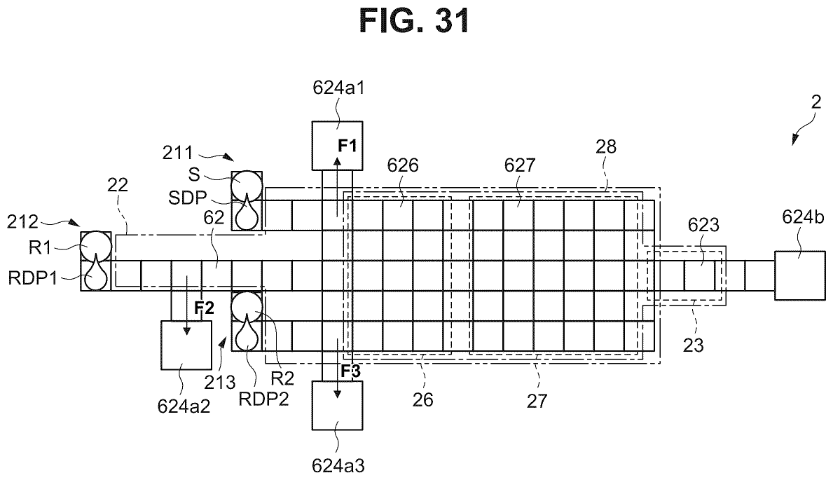

Hereinafter, a specific configuration of the first measurement unit 22 according to the present embodiment will be described with reference to FIG. 31. FIG. 31 is a schematic plan view illustrating a configuration example of the fluidic device 2 in the analysis apparatus 1 according to the fifth embodiment.

As illustrated in FIG. 31, the first measurement unit 22 is an image acquisition unit that acquires, for example, an image of the liquid droplet DP. In the present embodiment, the first measurement unit 22 acquires an image of the liquid droplet DP positioned in a region indicated by a dashed-two dotted line in FIG. 31. The region includes the mixing and agitating unit 26, the reaction unit 27, and the second measurement unit 23, and a flow path between these, for example. The first measurement unit 22 measures at least one of movement, mixing, agitating, and reaction of the liquid droplet DP based on the acquired image. For example, the first measurement unit 22 measures the size of the liquid droplet DP in the region over time. Alternatively, the first measurement unit 22 measures the size of the liquid droplet DP each time the liquid droplet DP moves between the electrodes 62. Further, the first measurement unit 22 measures the size of a mixed liquid droplet mixed and agitated on the electrode 626. Furthermore, the first measurement unit 22 measures the size of a mixed liquid droplet in which a reaction is performed on the electrode 627. In addition, the first measurement unit 22 measures the size of a mixed liquid droplet in which measurement related to the target substance is performed on the electrode 623. In the present embodiment, the determination function 42 of the processing circuitry 4 may determine whether the size of the liquid droplet DP is within the specified range, each time the liquid droplet DP moves between the electrodes 62, for example. The region to be monitored by the first measurement unit 22 is not limited to the example illustrated in FIG. 31, and may be set to any region.

As described above, according to the present embodiment, by the first measurement unit 22 monitoring the entire flow path of the fluidic device 2, the accuracy of the measurement related to a target substance can be improved. For example, by measuring the size of the liquid droplet DP on the second measurement unit 23, it is also possible to respond to a case where the size of the liquid droplet DP changes while being moved to the second measurement unit 23.

In the present embodiment, as in Modified Example 5 of the above-described first embodiment, a function of supplementing or dividing the liquid droplet DP in a case where it is determined that the size of the liquid droplet DP is not within the specified range may be included. This allows the system to respond, for example, a case where a portion of the liquid droplet DP remains or the liquid droplet DP is unintentionally fused with another liquid droplet when the liquid droplet DP is moved in the mixing and agitating unit 26 or the reaction unit 27.

### Sixth Embodiment

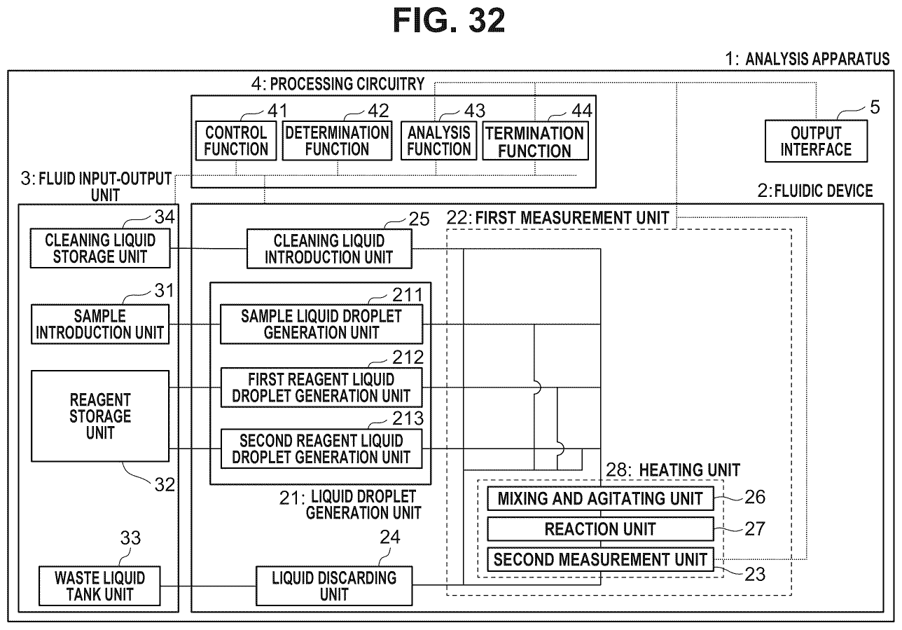

Next, a sixth embodiment including a function of terminating a test when a problem occurs in the fifth embodiment will be described. FIG. 32 is a block diagram illustrating a configuration example of an analysis apparatus 1 according to the sixth embodiment. Hereinafter, the present embodiment will be described mainly based on a difference from the fifth embodiment.

As illustrated in FIG. 32, processing circuitry 4 according to the present embodiment further includes a termination function 44. The termination function 44 terminates a test executed by the analysis apparatus 1, based on at least one of the property of the sample S, the contamination of the analysis apparatus 1, a failure in the first measurement unit 22, and a failure in the second measurement unit 23, for example. The termination function 44 serves as an example of a termination unit in the present embodiment.

The property of the sample S means whether it is determined that it is impossible to generate a sample liquid droplet SP of a size within a specified range using the sample S. For example, in a case where the sample liquid droplet SP of a size within the specified range cannot be generated after the sample liquid droplet generation unit 211 has repeated the generation of the sample liquid droplet SP a predefined number of times, the termination function 44 determines that the generation of a sample liquid droplet SP of a size within the specified range is inexecutable, and terminates a test by the analysis apparatus 1, based on the property of the sample S. The predefined number of times is prestored in storage circuitry, for example. The predefined number of times may be set by the user. Further, by using a similar method, the termination function 44 may terminate a test by the analysis apparatus 1, based on the properties of the first reagent R1 and the second reagent R2.

The contamination of the analysis apparatus 1 refers to, for example, a case where a portion of the liquid droplet DP remains in a flow path of the fluidic device 2. For example, the termination function 44 determines whether a portion of the liquid droplet DP remains on the electrodes 62, based on an image acquired by the first measurement unit 22. In a case where it is determined that a portion of the liquid droplet DP remains, the termination function 44 terminates a test by the analysis apparatus 1, based on the contamination of the analysis apparatus 1.

The failures in the first measurement unit 22 and the second measurement unit 23 refers to a case where the first measurement unit 22 and the second measurement unit 23 are caused to perform the measurement of control, and it is determined that a problem occurs in at least one measurement result, for example. The measurement of control is performed using, for example, a standard sample. For example, in a case where the size of the sample liquid droplet SDP containing the standard sample is not within a specified range, or in a case where a result of measurement related to a target substance that has been performed using the sample liquid droplet SDP containing a standard sample is not within a specified range, the termination function 44 terminates a test by the analysis apparatus 1, based on the failures in the first measurement unit 22 and the second measurement unit 23.

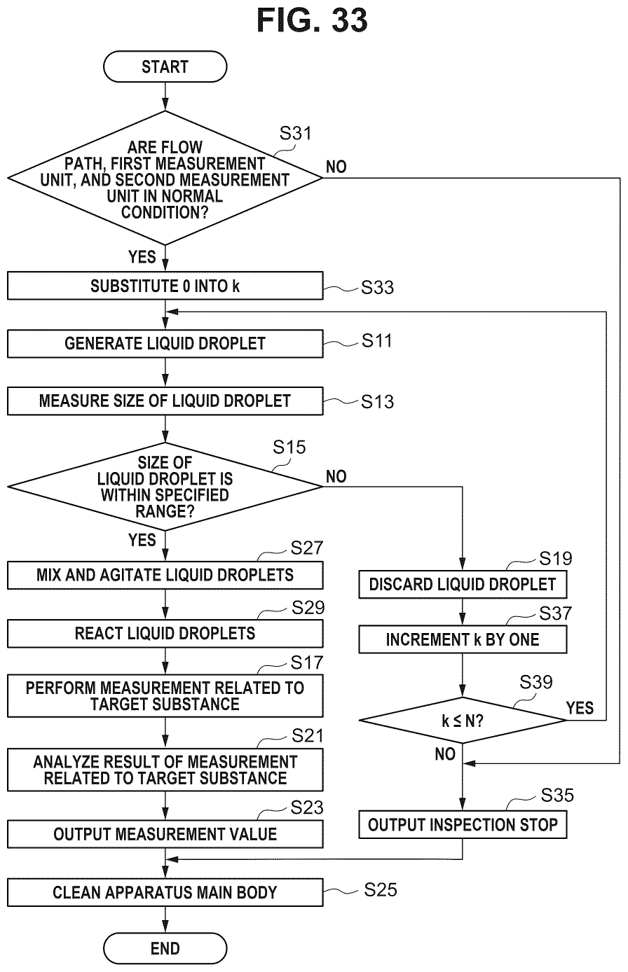

Next, an operation example of the analysis apparatus 1 according to the sixth embodiment that has the above-described configuration will be described with reference to FIG. 33. FIG. 33 is a flowchart illustrating an operation example of the analysis apparatus 1 according to the sixth embodiment.

As illustrated in FIG. 33, first of all, in step S31, it is determined whether a flow path, the first measurement unit 22, and the second measurement unit 23 are in a normal condition. For example, by controlling the first measurement unit 22, the termination function 44 of the processing circuitry 4 causes the first measurement unit 22 to acquire an image of a flow path of the fluidic device 2. After that, the termination function 44 determines whether a portion of the liquid droplet DP remains, based on the acquired image. Subsequently, the termination function 44 causes the first measurement unit 22 to perform the measurement of control, and determines whether there is a failure in the first measurement unit 22. Then, the termination function 44 causes the second measurement unit 23 to perform the measurement of control, and determines whether there is a failure in the second measurement unit 23.

In a case where it is determined that the flow path, the first measurement unit 22, and the second measurement unit 23 are in a normal condition (YES in step S31), the processing proceeds to step S33. In step S33, 0 is substituted into k. More specifically, the termination function 44 of the processing circuitry 4 prepares k as an internal parameter, for example, substitutes 0 into k, and stores k into storage circuitry. The parameter k denotes the number of attempts made to generate the sample liquid droplet SDP.

On the other hand, in a case where it is determined that the flow path, the first measurement unit 22, and the second measurement unit 23 are not in a normal condition (NO in step S31), that is, in a case where it is determined that at least one of the flow path, the first measurement unit 22, and the second measurement unit 23 is not in a normal condition, the processing proceeds to step S35. In step S35, a test termination is output. More specifically, the termination function 44 of the processing circuitry 4 causes the output interface 5 to output error display.

After step S33, the above-described processing in steps S11 to S15 is performed. Further, in step S15, in a case where it is determined that the size of the liquid droplet is within the specified range (YES in step S15), the processing proceeds to step S27. The above-described processing in steps S27 to S25 is performed. On the other hand, in step S15, in a case where it is determined that the size of the liquid droplet is not within the specified range (NO in step S15), the processing proceeds to step S19. The above-described processing in step S19 is performed.

After step S19, in step S37, the parameter k is incremented by one. More specifically, the termination function 44 of the processing circuitry 4 substitutes k+1 into k, and stores the value into the storage circuitry.

Next, in step S39, it is determined whether k is equal to or smaller than N. More specifically, the termination function 44 of the processing circuitry 4 determines whether k indicating the number of attempts to generate the sample liquid droplet SDP is equal to or smaller than N indicating the predefined number of times.

In a case where it is determined that k is equal to or smaller than N (YES in step S39), the processing returns to step S11, and a liquid droplet is generated again. In the present embodiment, the sample liquid droplet SDP is generated again.

On the other hand, in a case where it is determined that k is not equal to or smaller than N (NO in step S39), the processing returns to step S35. That is, in a case where k indicating the number of attempts to generate the sample liquid droplet SDP exceeds N indicating the predefined number of times, the termination function 44 of the processing circuitry 4 causes the output interface 5 to output error display. After that, the above-described processing in step S25 is performed.

Through the above-described steps, the operation according to the present embodiment the analysis apparatus 1 ends.

The error display in step S35 may include information indicating whether the cause of the error is attributable to the property of the sample S, the contamination of the analysis apparatus 1, the failure in the first measurement unit 22, or the failure in the second measurement unit 23.

As described above, according to the present embodiment, by terminating a test when a problem occurs, it is possible to avoid the unnecessary consumption of a sample or a reagent.

The term “processor” used in the description of the foregoing embodiments refers to a circuit such as a central processing unit (CPU), a graphics processing unit (GPU), an application specific integrated circuit (ASIC), and a programmable logic device (e.g., a simple programmable logic device [SPLD], a complex programmable logic device [CPLD], or a field programmable gate array [FPGA]). The processor implements its functions by reading and executing a program stored in memory circuitry. Instead of storing the programs in the storage circuitry, the processor may be configured to have the program directly embedded within its circuitry. In such a case, the processor implements the functions by reading the embedded programs and executing the programs. The processor may be configured not only as single circuitry, but also as a combination of a plurality of independent circuitry functioning collectively as a single processor that implements the functions. Furthermore, the plurality of components illustrated in FIG. 1 may be integrated into a single processor to implement the described functions.

According to at least one of the embodiments described above, it is possible to reduce the influence of the size of a generated liquid droplet on a measurement result related to a target substance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An analysis apparatus that performs analysis related to a target substance included in a sample, by moving a liquid droplet through application of an electric field, the analysis apparatus comprising:
a liquid droplet generation unit configured to generate a liquid droplet to be used for the analysis;
a first measurement unit configured to measure a size of the liquid droplet;
a second measurement unit configured to perform measurement related to the target substance using the liquid droplet; and
processing circuitry configured to analyze an amount of the target substance in the sample based on a measured size of the liquid droplet and a result of the measurement related to the target substance.

2. The analysis apparatus according to claim 1, wherein the processing circuitry further corrects the result of the measurement related to the target substance based on the measured size of the liquid droplet.

3. The analysis apparatus according to claim 1, wherein the first measurement unit includes an image acquisition unit configured to acquire an image of the liquid droplet.

4. The analysis apparatus according to claim 1, wherein the first measurement unit includes an impedance acquisition unit configured to acquire an impedance of the liquid droplet.

5. The analysis apparatus according to claim 1, wherein the second measurement unit performs at least one of an optical measurement, an electrochemical measurement, and a hue measurement that is related to the liquid droplet.

6. The analysis apparatus according to claim 1,
wherein the processing circuitry further determines whether the measured size of the liquid droplet is within a specified range, and
wherein the analysis apparatus further includes a liquid discarding unit for discarding the liquid droplet in a case where it is determined that the size is not within the specified range.

7. The analysis apparatus according to claim 6, further comprising a flow path configured to transfer the liquid droplet to the liquid discarding unit without passing through a flow path to the second measurement unit, in a case where it is determined that the size is not within the specified range.

8. The analysis apparatus according to claim 7, further comprising
a plurality of electrodes configured to apply the electric field,
wherein the plurality of electrodes includes
a first flow path along which a liquid droplet measured by the first measurement unit is moved to cause the second measurement unit to measure the liquid droplet, and
a second flow path, different from the first flow path, along which the liquid droplet measured by the first measurement unit is moved to the liquid discarding unit.

9. The analysis apparatus according to claim 6, wherein, in a case where it is determined that the size is smaller than the specified range, the liquid droplet generation unit further generates a supplement liquid droplet for supplementing the liquid droplet.

10. The analysis apparatus according to claim 6, further comprising a dividing unit configured to divide, in a case where it is determined that the size is larger than the specified range, the liquid droplet into a plurality of liquid droplets with a size smaller than that of the liquid droplet by application of an electric field.

11. The analysis apparatus according to claim 1,
wherein the liquid droplet generation unit includes a sample liquid droplet generation unit that generates a sample liquid droplet containing the sample, as the liquid droplet, and a reagent liquid droplet generation unit that generates a reagent liquid droplet containing a reagent to be used for the analysis, as the liquid droplet, and
wherein the analysis apparatus further includes a mixing and agitating unit for mixing and agitating the sample liquid droplet and the reagent liquid droplet.

12. The analysis apparatus according to claim 11, further comprising a reaction unit for reacting a mixed liquid droplet of the sample liquid droplet and the reagent liquid droplet.

13. The analysis apparatus according to claim 1, further comprising a heating unit for heating the liquid droplet.

14. The analysis apparatus according to claim 1, wherein the first measurement unit further measures at least one of movement, mixing, agitating, and a reaction of the liquid droplet.

15. The analysis apparatus according to claim 1, wherein the processing circuitry further terminates a test executed by the analysis apparatus, based on at least one of a property of the sample, contamination of the analysis apparatus, a failure in the first measurement unit, and a failure in the second measurement unit.

16. An analysis method for performing analysis related to a target substance included in a sample by moving a liquid droplet through application of an electric field, the analysis method comprising:
generating a liquid droplet to be used for the analysis;
measuring a size of the liquid droplet;
performing measurement related to the target substance using the liquid droplet; and
analyzing an amount of the target substance in the sample based on a measured size of the liquid droplet and a result of the measurement related to the target substance.
